(19) United States
(12) Patent Application Publication
(10) Pub. No.: US 2016/0321762 A1
(43) Pub. Date: Nov. 3, 2016

(54) LOCATION-BASED GROUP MEDIA SOCIAL NETWORKS, PROGRAM PRODUCTS, AND ASSOCIATED METHODS OF USE

(71) Applicant: Joseph Schuman, New York, NY (US)

(72) Inventor: Joseph Schuman, New York, NY (US)

(21) Appl. No.: 15/105,858

(22) PCT Filed: Nov. 25, 2014
(86) PCT No.: PCT/US14/67430

§ 371 Date: Jun. 17, 2016

Related U.S. Application Data
(60) Provisional application No. 61/917,699, filed on Dec. 18, 2013.
(60) Provisional application No. 61/935,143, filed on Feb. 3, 2014.

(51) Int. Cl. G06Q 50/00; G06Q 20/22; G06F 17/30; G06Q 30/02

(52) U.S. Cl. CPC G06Q 50/01; G06Q 30/0269; G06Q 20/29; G06F 17/30864

(57) ABSTRACT

A social media server is disclosed, and comprises one or more processors to implement a set of instructions stored on one or more non-transitory computer-readable memory devices upon which a set of instructions are stored. A user group data storage module is electronically coupled with the one or more non-transitory computer-readable memory devices and includes data associated with a plurality of user groups of the social media server, each user group containing a plurality of individual users. A matching module is electronically coupled with the one or more non-transitory computer-readable memory devices and is configured to match at least one data set associated with at least one user group of the plurality of user groups with at least one data set associated with at least one other user group of the plurality of user groups.

### CROSS-REFERENCE TO RELATED APPLICATIONS

The present application claims the benefit of and priority to each of U.S. Provisional Patent Application No. 61/917,699, filed on Dec. 18, 2013 and U.S. Provisional Patent Application No. 61/935,143, filed on Feb. 3, 2014, the entire contents of each of which are incorporated by reference herein.

### FIELD

The present disclosure generally relates to social media networks, program products, and methods of using the same for facilitating communication among a plurality of user groups

Social media networks are designed to facilitate communication between individual member users for a variety of purposes, for example, professional networking, connecting with others having common interests, or romantic ventures such as dating, to name a few. The dawn of the internet age has seen a proliferation of social media networks designed to bring individual users to a physical meeting by facilitating first communication through the respective social media network, for example, okCupid, Match, and Tinder

### SUMMARY

Challenges may be presented to the individual user of a social media network faced with the prospect of a live meeting with another previously-unknown individual, for example, concerns over maintaining conversation, planning activities, and/or safety. Such concerns may create a hindrance or barrier to a user making full use of the social networking experience. In response, some social media networks have arisen that provide group-based social networking that facilitates the initial contact and later meeting of groups of multiple individuals, for example, Grouper and WhyDontWe. Such social networking schemes can be advantageous in that they allow users to participate in social networking with the degree of comfort afforded by a group environment.

Still, there is a need for social media networks, program products, and associated methods that provide the advantages of group-based social networking, while additionally providing a substantially realtime environment in which this social networking takes place. It would also be desirable for such social media networks, program products, and associated methods to capitalize on the increased tendency of already-assembled or already-associated groups of users to socialize with other group of users due to the spontaneity of such socialization and/or the convenience of accessibility to other groups of users within a common geographic location or geographic region.

In an exemplary embodiment of the present invention, a social media server is disclosed, and comprises one or more processors, one or more non-transitory computer-readable memory devices upon which a set of instructions is stored, a user group data storage module, a matching module, and a communication module. The one or more non-transitory computer-readable memory devices are electronically coupled with the one or more processors to implement at least one instruction of the set of instructions. The user group data storage module is electronically coupled to the one or more non-transitory computer-readable memory devices and includes data associated with a plurality of user groups of the social media server, each user group containing a plurality of individual users. The matching module is electronically coupled with the one or more non-transitory computer-readable memory devices and is configured to match at least one data set associated with at least one user group of the plurality of user groups with at least one data set associated with at least one other user group of the plurality of user groups. The communication module is electronically coupled with the one or more non-transitory computer-readable memory devices and provides substantially realtime communication between the at least one user group and the at least one other user group upon a matching by the matching module.

In exemplary embodiments, the at least one data set associated with the at least one user group and the at least one data set associated with the at least one other user group correspond to a location of the respective user groups.

In exemplary embodiments, each respective location is within a common geographic region.

In exemplary embodiments, each respective location is within a common geographic location.

In exemplary embodiments, a commercial content module is electronically coupled with the one or more non-transitory computer readable-memory devices for transmitting data associated with commercial content to one or more electronic devices electronically coupled with the social media server.

In exemplary embodiments, the data associated with commercial content is an advertisement for a good or service.

In exemplary embodiments, the data associated with commercial content is an offer for a discount for a good or service.

In exemplary embodiments, the commercial content module transmits data associated with commercial content to the one or more electronic devices based upon a physical location of the one or more electronic devices.

In exemplary embodiments, the commercial content module transmits data associated with commercial content to one or more other electronic devices based on a proximity of the one or more electronic devices to the one or more other electronic devices.

In exemplary embodiments, the social media server further comprises a group payment module electronically coupled with the one or more non-transitory computer-readable memory devices and is configured to apply an electronic payment from one or more user groups of the plurality of user groups to a good or service.

In exemplary embodiments, the group payment module is configured to divide a total cost of a good or service among a respective plurality of individual users of the one or more user group of the plurality of user groups.

In exemplary embodiments, the social media server further comprises an application programming interface module electronically coupled with the one or more non-transitory computer-readable memory devices for communicating with one or more third party services external to the social media server.

In exemplary embodiments, the application programming interface module is configured to transmit data to the one or more third party services.

In exemplary embodiments, the application programming interface module is configured to retrieve data from the one or more third party services.

In an exemplary embodiment of the present invention, a social media server is disclosed, and comprises one or more processors, one or more non-transitory computer-readable memory devices upon which a set of instructions is stored, a user group data storage module, a matching module, a communication module, and a commercial content module. The one or more non-transitory computer-readable memory devices are electronically coupled with the one or more processors to implement at least one instruction of the set of instructions. The user group data storage module is electronically coupled with the one or more non-transitory computer-readable memory devices and includes data associated with a plurality of user groups of the social media server, each user group containing a plurality of individual users. The commercial content module is electronically coupled with the one or more non-transitory computer readable-memory devices for transmitting data associated with commercial content to one or more electronic devices electronically coupled with the social media server based upon data associated with one or more user groups of the plurality of user groups.

In an exemplary embodiment of the present invention, a method is disclosed, and comprises: (a) retrieving, by a social media server having one or more processors configured to read one or more instructions of a set of instructions stored on a non-transitory computer-readable medium, a first set of data associated with one or more user groups of a plurality of user groups electronically coupled with the social media server; (b) retrieving, by the social media server, a second set of data associated with another one or more user groups of the plurality of user groups; (c) matching, by a matching module of the social media server, the one or more user groups with the another one or more user groups based upon the first set of data and the second set of data; and (d) providing, by a communication module of the social media server, substantially realtime communication between the one or more user groups and the another one or more user groups based upon a match by the matching module.

In exemplary embodiments, the first set of data and the second set of data correspond to a common location of the respective user groups.

In exemplary embodiments, the method further comprises the step of transmitting, by a commercial content module of the social media server, data associated with advertisements for goods or services to one or more electronic devices electronically coupled with the social media server.

In exemplary embodiments, the method further comprises the step of transmitting, by a commercial content module of the social media server, data associated with offers for discounts for goods or services to one or more electronic devices electronically coupled with the social media server.

In exemplary embodiments, the method further comprises the step of transmitting data, by an application programming interface module of the social media server, to one or more third party services external to the social media server.

In exemplary embodiments, the method further comprises the step of retrieving data, by an application programming interface module of the social media server, from one or more third party services external to the social media server.

In exemplary embodiments, the method further comprises the step of applying an electronic payment, by a group payment module of the social media server, to a good or service.

### BRIEF DESCRIPTION OF THE DRAWINGS

Various exemplary embodiments of this invention will be described in detail, with reference to the following figures, wherein:

FIG. 1 is a schematic diagram of a social media network according to an exemplary embodiment of the present invention;

FIG. 2 is a schematic diagram of a subscriber device configured for use with the social media network of FIG. 1 according to an exemplary embodiment of the present invention;

FIG. 3 is a schematic diagram of a social media server configured for use with the social media network of FIG. 1 according to an exemplary embodiment of the present invention;

FIG. 4A is a schematic diagram of a configuration of a portion of the social media network of FIG. 1 according to an exemplary embodiment of the present invention;

FIG. 4B is a schematic diagram of a configuration of a portion of the social media network of FIG. 1 according to another exemplary embodiment of the present invention;

FIG. 5 is a process flow of a series of processes occurring across a social media server configured for use with the social media network of FIG. 1 according to an exemplary embodiment of the present invention;

FIG. 6 is a flow chart of a series of processes occurring across a social media server configured for use with the social media network of FIG. 1 according to an exemplary embodiment of the present invention;

FIG. 7 is a flow chart of a series of processes occurring across a social media server configured for use with the social media network of FIG. 1 according to an exemplary embodiment of the present invention;

FIG. 8A is a screenshot of a graphic user interface for displaying information associated with a program product supported on a social media server configured for use with the social media network of FIG. 1 according to an exemplary embodiment of the present invention;

FIG. 8B is another screenshot of a graphic user interface for displaying information associated with a program product supported on a social media server configured for use with the social media network of FIG. 1 according to an exemplary embodiment of the present invention;

FIG. 8C is another screenshot of a graphic user interface for displaying information associated with a program product supported on a social media server configured for use with the social media network of FIG. 1 according to an exemplary embodiment of the present invention;

FIG. 8D is another screenshot of a graphic user interface for displaying information associated with a program product supported on a social media server configured for use with the social media network of FIG. 1 according to an exemplary embodiment of the present invention;

FIG. 8E is another screenshot of a graphic user interface for displaying information associated with a program product supported on a social media server configured for use with the social media network of FIG. 1 according to an exemplary embodiment of the present invention;

FIG. 8F is another screenshot of a graphic user interface for displaying information associated with a program product supported on a social media server configured for use with the social media network of FIG. 1 according to an exemplary embodiment of the present invention;

FIG. 8G is another screenshot of a graphic user interface for displaying information associated with a program product supported on a social media server configured for use with the social media network of FIG. 1 according to an exemplary embodiment of the present invention;

FIG. 8H is another screenshot of a graphic user interface for displaying information associated with a program product supported on a social media server configured for use with the social media network of FIG. 1 according to an exemplary embodiment of the present invention;

FIG. 8I is another screenshot of a graphic user interface for displaying information associated with a program product supported on a social media server configured for use with the social media network of FIG. 1 according to an exemplary embodiment of the present invention;

FIG. 8J is another screenshot of a graphic user interface for displaying information associated with a program product supported on a social media server configured for use with the social media network of FIG. 1 according to an exemplary embodiment of the present invention;

FIG. 8K is another screenshot of a graphic user interface for displaying information associated with a program product supported on a social media server configured for use with the social media network of FIG. 1 according to an exemplary embodiment of the present invention;

FIG. 8L is another screenshot of a graphic user interface for displaying information associated with a program product supported on a social media server configured for use with the social media network of FIG. 1 according to an exemplary embodiment of the present invention;

FIG. 8M is another screenshot of a graphic user interface for displaying information associated with a program product supported on a social media server configured for use with the social media network of FIG. 1 according to an exemplary embodiment of the present invention;

FIG. 8N is another screenshot of a graphic user interface for displaying information associated with a program product supported on a social media server configured for use with the social media network of FIG. 1 according to an exemplary embodiment of the present invention;

FIG. 8O is another screenshot of a graphic user interface for displaying information associated with a program product supported on a social media server configured for use with the social media network of FIG. 1 according to an exemplary embodiment of the present invention;

FIG. 8P is another screenshot of a graphic user interface for displaying information associated with a program product supported on a social media server configured for use with the social media network of FIG. 1 according to an exemplary embodiment of the present invention;

FIG. 8Q is another screenshot of a graphic user interface for displaying information associated with a program product supported on a social media server configured for use with the social media network of FIG. 1 according to an exemplary embodiment of the present invention;

FIG. 8R is another screenshot of a graphic user interface for displaying information associated with a program product supported on a social media server configured for use with the social media network of FIG. 1 according to an exemplary embodiment of the present invention;

FIG. 8S is another screenshot of a graphic user interface for displaying information associated with a program product supported on a social media server configured for use with the social media network of FIG. 1 according to an exemplary embodiment of the present invention;

FIG. 8T is another screenshot of a graphic user interface for displaying information associated with a program product supported on a social media server configured for use with the social media network of FIG. 1 according to an exemplary embodiment of the present invention;

FIG. 8U is another screenshot of a graphic user interface for displaying information associated with a program product supported on a social media server configured for use with the social media network of FIG. 1 according to an exemplary embodiment of the present invention; and

FIG. 8V is another screenshot of a graphic user interface for displaying information associated with a program product supported on a social media server configured for use with the social media network of FIG. 1 according to an exemplary embodiment of the present invention.

### DETAILED DESCRIPTION

The present invention generally relates to social media networks, program products, and methods of using the same for facilitating communication among a plurality of user groups within a predetermined geographic region.

As used herein, the term “geographic region” refers to a bounded area that can include a plurality of locations, for example, buildings or other structures, city blocks or property zones, and/or interconnecting roadways. In this regard, a geographic region can include a neighborhood, town, city, municipality, county, state, or country.

As used herein, the term “geographic location” refers to a specific point or area within a geographic region, for example, a building or other structure, intersection, landmark, and/or GPS coordinates.

In exemplary embodiments described herein, a social media network is disclosed that comprises a plurality of distinct user groups interconnected across a social media server so that at least one group of users can communicate with at least one other group of users. Each group of users is comprised of at least two individual users that are associated on a portion of social media server, for example, by a common group registration or subscription. A group of users may be formed in an ad hoc manner by a plurality of individual users located within a common geographic region and/or geographic location. In this regard, each user group represents a plurality of users already engaged in a social situation by virtue of a common interest (e.g., membership within a user group) and/or their assembly at a relatively common geographic region and/or geographic location. As described herein, user groups can additionally or alternatively be formed and/or altered when one or more individual user members of the user group are not within a relatively common geographic region and/or geographic location, e.g., in an ephemeral fashion.

Social media networks, program products, and associated methods disclosed herein may be configured to facilitate communication between groups of users substantially in realtime so that the challenges presented to individual socialization are mitigated by virtue of one or more individual users' presence within a group of users. Further, groups that are in communication with one another are presented with the possibility of physically meeting other groups of users at nearby locations within a specific geographic region and/or geographic location. Accordingly, the social media networks described herein are configured to capitalize on one or both of group-based social networking and the increased social behaviors associated with substantially realtime communication with nearby user groups.

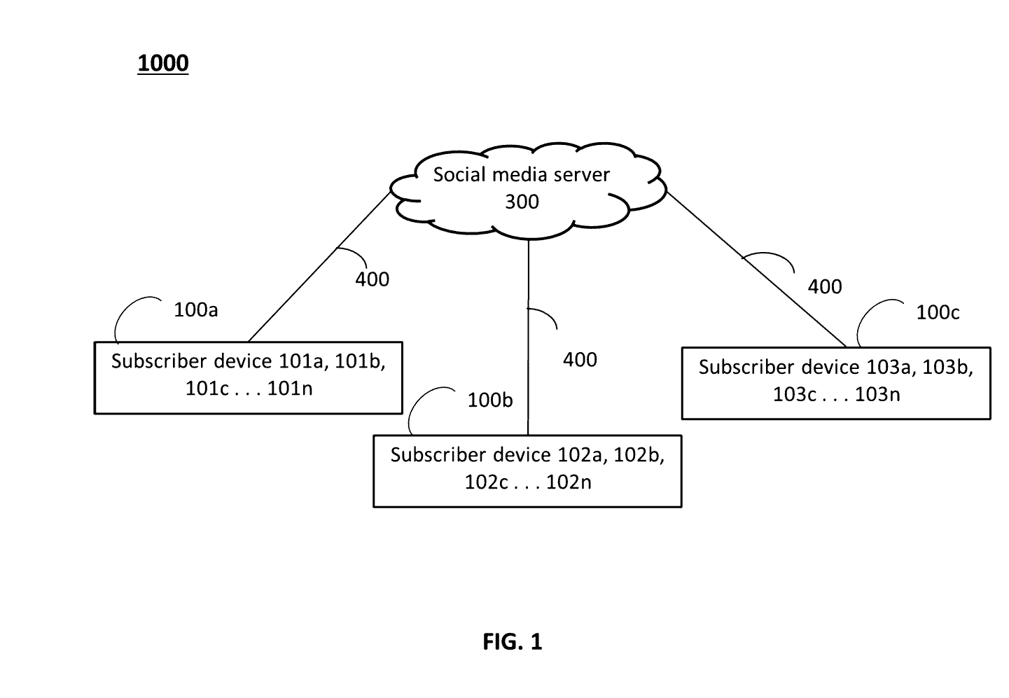

Turning to FIG. 1, an exemplary embodiment of a social media network is generally designated 1000. Social media network 1000 may be an interconnection of elements that includes a plurality of user groups 100a, 100b, 100c and a social media server 300. Each user group 100a, 100b, 100c . . . 100n may include a respective plurality of user devices 101a, 101b, 101c . . . 101n; 102a, 102b, 102c . . . 102n; 103a, 103b, 103c . . . 103n that are connected to a social media server 300 via a data network 400. While three user groups are illustrated in the exemplary embodiment herein social media network 1000 can include a different number of user groups, for example, a greater or lesser number of user groups.

Subscriber devices 100 101a, 101b, 101c . . . 101n; 102a, 102b, 102c . . . 102n; 103a, 103b, 103c . . . 103n are devices that are electronically coupleable with social media server 300 and configured to relay data therebetween. Subscriber devices 101a, 101b, 101c . . . 101n; 102a, 102b, 102c . . . 102n; 103a, 103b, 103c . . . 103n are capable of receiving a physical input from one or more users, e.g., a tactile, motion-based, and/or audio input, and converting the physical input into data for transmission to social media server 300. Subscriber devices 101a, 101b, 101c . . . 101n; 102a, 102b, 102c . . . 102n; 103a, 103b, 103c . . . 103n can also display/or project information relayed from social media 300 in a format that is visible, audible, and/or otherwise capable of being received by one or more human operators of subscriber devices 101a, 101b, 101c . . . 101n; 102a, 102b, 102c . . . 102n; 103a, 103b, 103c . . . 103n.

In this regard, subscriber devices 101a, 101b, 101c . . . 101n; 102a, 102b, 102c . . . 102n; 103a, 103b, 103c . . . 103n are electronic devices configured for the display and/or projection of content associated with social media server 400 and/or communication with one or more subscriber devices 101a, 101b, 101c . . . 101n; 102a, 102b, 102c . . . 102n; 103a, 103b, 103c . . . 103n and/or one or more user groups 100a, 100b, 100c . . . 100n across social media server 300. Subscriber devices 101a, 101b, 101c . . . 101n; 102a, 102b, 102c . . . 102n; 103a, 103b, 103c . . . 103n can be, for example, smartphones, tablet computers, laptop computers, desktop computers, and/or wearable computers such as smartwatches or other bodily-mounted computing devices, e.g., Google Glass™.

Still referring to FIG. 1, and as described above, the subscriber devices 101a, 101b, 101c . . . 101n; 102a, 102b, 102c . . . 102n; and 103a, 103b, 103c . . . 103n are in electronic communication with social media server 300 across data network 400. Data network 400 may be a wired and/or wireless data communication system, such as the Internet, a mobile data network (e.g., cellular or satellite), and/or a local intranet. Data network 400 may include a mesh network, e.g., a network formed of one or more local modalities of data communication, for example, Wi-Fi, infrared, Z-wave, near-field communication (NFC), and/or Bluetooth data transmission. Such a mesh network or portions thereof can transmit information across portions of social media network 1000 in situations in which an external data connection provider, such as a land-based or mobile data connection provider, experiences an outage.

Accordingly, subscriber devices 101a, 101b, 101c . . . 101n; 102a, 102b, 102c . . . 102n; 103a, 103b, 103c . . . 103n and/or portions of social media server 300 can include interface software and/or hardware, such as that necessary to support wired or wireless and connections and/or communications for connection to social media server 300 across data network 400. Wired connections may be adapted for use with, for example, cable, POTS (telephone), fiber (such as Hybrid Fiber Coaxial), xDSL, coaxial cable, fiber, copper wire (such as twisted pair copper wire), and/or combinations thereof. Wireless connections may include any cellular or cellular data connections, for example digital cellular, PCS, CDPD, GPRS, CDMA2000, Ev-DO, HSPA, UMTS), Bluetooth, Wi-Fi, radio, satellite, infrared connections, and/or other electromagnetic waves. Interface hardware and/or software, which may be used to communicate over wired and/or wireless connections, may comprise any of Ethernet interfaces (e.g., supporting a TCP/IP stack), X.25 interfaces, T1 interfaces, and/or antennas. One or more communications portals (e.g., a communications portal of a device) may handle, process, support, and/or perform any wired and/or wireless communications and may comprise hardware and/or software.

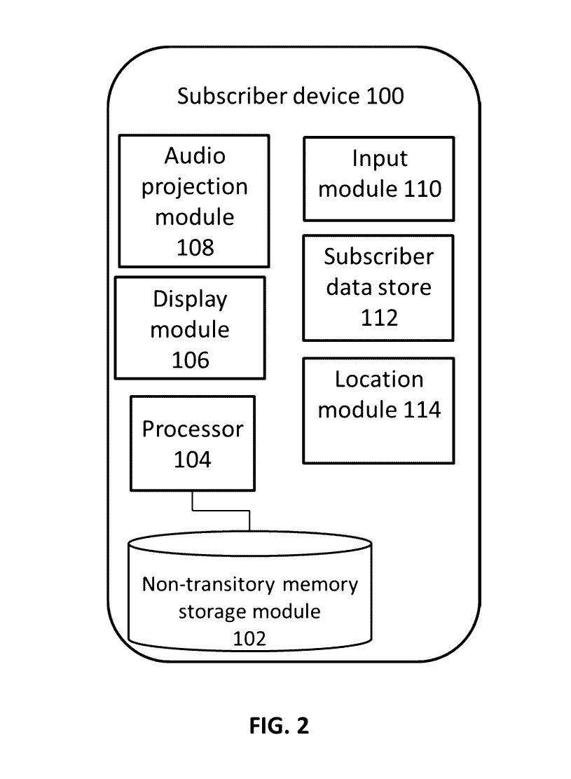

Referring additionally to FIG. 2, a schematic diagram of a subscriber device 100 is illustrated. Subscriber device 100 as described herein may be representative of or similarly configured to any of subscriber devices 101a, 101b, 101c . . . 101n; 102a, 102b, 102c . . . 102n; 103a, 103b, 103c . . . 103n. One or more of subscriber devices 101a, 101b, 101c . . . 101n; 102a, 102b, 102c . . . 102n; 103a, 103b, 103c . . . 103n may have different a configuration than subscriber device 100.

As described above, subscriber device 100 is a portable electronic device for use with social media server 1000. Subscriber device 100 may be configured to run a program product, e.g., computer code or other machine-executable instructions associated with social media server 300. Accordingly, subscriber device 100 may include one or more non-transitory memory storage devices 102 upon which computer-readable instructions may be read. Subscriber device 100 includes one or more processors 104 electronically coupled with the one or more non-transitory memory storage devices 102 so that a computer program product or other code or language associated with social media server 300 can be run on subscriber device 100.

As shown, subscriber device 100 may include one or more modules for handling various processes supporting the generation and/or transmission of data associated with social media communications. Modules described herein with respect to subscriber device 100 may have associated hardware or may be installed on specific hardware. In embodiments, any function attributed to any module described herein may be performed wholly or in part by one or more other modules.

In the exemplary embodiment shown, subscriber device 100 may include a display module 106 for displaying information received from social media server 300. In this regard, display module 106 displays content created and/or stored on subscriber device 100. Display module 106 may be configured to display visual images, such as 2D images, e.g., still images or video, or 3D images such as holographic images. Accordingly, display module 106 is electronically coupled with a visual display element, for example, an LCD screen, text display, or other electronic display.

Subscriber device 100 may include an audio projection module 108 for projection of data transmitted by social media server 300 as audible sounds. In this regard, audio projection module 108 is configured to cause the operation of a hardware element of subscriber device 100, for example, an audio speaker.

Subscriber device 100 may include an input module 110 for receiving one or more physical inputs from a user, for example, a tactile input (such as the pressing of a button or contact with a capacitive touchscreen device), an audio input (such as a voice input), and/or a motion-based input (such as a hand or palm swipe, or the shaking or moving of a device). In this regard, input module 110 may be operatively and electronically coupled with one or more hardware devices of subscriber device 100, for example, a microphone, keyboard, trackball or sensor pad, capacitive touchscreen, and/or accelerometer.

Subscriber device 100 includes a subscriber data store 112 for storing data related to one or more users associated with subscriber device 100. Subscriber data store 112 may include data associated with an account or registration with a program product hosted on social media server 300, for example, login information such as a username or account password. Subscriber data store 112 of subscriber device 100 may include media content for use with social media server 300, for example, photos, videos, and/or songs, to name a few.

Subscriber device 100 may include a location module 114 for determining a location of subscriber device 100 and/or transmitting location information to social media server 300. Location module 114 includes one or more hardware and/or software elements configured to determine a geographic region and/or geographic location in which a subscriber device 100 is located, for example, a mobile data antenna and/or GPS antenna.

As described further herein, at least two users (typically, individual human operators of respective subscriber devices 101a, 101b, 101c . . . 101n; 102a, 102b, 102c . . . 102n; 103a, 103b, 103c . . . 103n) can together comprise a user group. However, users not associated with subscriber devices electronically coupled with social media network 1000 may form a user group, for example, members of an organization or school. A user group may have a different number of users than associated subscriber devices, for example, if more than one user is sharing a subscriber device. As described herein, a user group is sometimes designated a “crew” within social media network 1000.

Full participation in social media network 1000 may be provided to members of a user group, while individual users associated with social media network 1000 may be restricted from some aspects of participation unless or until they are members of a user group. As described herein, the term user can refer an individual user or subscriber (e.g., registered account holder) of a product or service supported by social media server 300, e.g., a computer program product or application supported by social media server 300. A user can be a different type of individual, for example, a guest of a subscriber, a system administrator, or an automatic (e.g. computer-controlled) process of social media server 300. Limits on the size and/or composition of a user group may be imposed by a portion of social media server 300, for example, a ratio, minimum, and/or maximum number of individual users within a user group of a specific gender to the total membership of a user group.

As described further herein, social media network 1000 is configured to facilitate communication between different user groups (e.g., 100a, 100b, 100c . . . 100n). Social media network 1000 can additionally or alternatively configured to facilitate communication between individual members of user groups 100a, 100b, 100c . . . 100n. Such communication may be in the form of audio transmission, video transmission, and/or textual transmission (such as SMS or electronic mail), any of which may be substantially real-time transmissions and/or pre-recorded content that are electronically transmitted across data network 400 and through social media server 300. Such communication may be indirect, for example, the sharing or tagging of media content without directly engaging a member of another user group in real-time textual, audio, and/or visual dialogue.

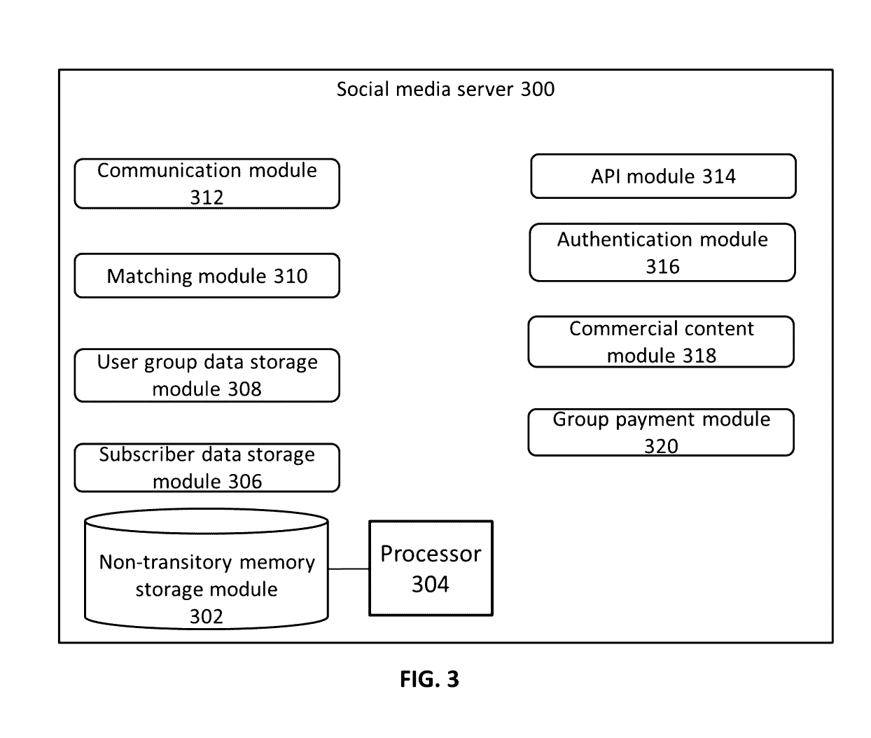

Still referring to FIG. 1 and FIG. 2, and referring additionally to FIG. 3, a schematic diagram of various components of social media server 300 is illustrated. As described herein, social media server 300 is configured to receive, store, manipulate and/or transmit for display and/or projection electronic data associated with communications and/or media content transmitted across social media network 1000. Social media server 300 may include one or more real and/or virtual data servers, such as in a cloud computing environment, so that data can be transmitted between different components of social media server 300. Social media server 300 or portions thereof may be provided, owned, and/or operated by a single entity, such as a natural person, or a legal entity, such as a company or service.

Social media server 300 is configured to carry out a series of steps or processes directed to electronic data corresponding to communications and/or media content transmitted across social media network 1000. Such steps may be one or more sets of instructions, rules, boundaries, and/or algorithms, to name a few, that result in the manipulation, modification, and/or transformation of a portion of the electronic data corresponding to such communications and/or content.

In this regard, the entirety of or portions of alert communication server 300 may be formed of one or more computer systems having one or more computers. The computers may store data in one or more databases stored on storage devices having computer-readable memory. Storage devices can include one or more non-transitory computer readable memory storage devices 302, such as hard drives, flash memory, tapes, disks, CDs, DVDs, memory cards, server farms, and any hardware necessary to read and/or write to such non-transitory memory, such as disk drives, automatic or robotic disk loaders, CD drives, and/or memory card writers. The computers may also have one or more modules run by on one or more processors 304 that are electronically coupled with the non-transitory memory storage devices 302 of the computers. In embodiments, the modules may provide user interfaces for interacting (e.g., inputting data and/or receiving data) with a computer system. Accordingly, any of the computers may also include input devices (e.g., keyboards, cameras, touchpads, computer mouse devices, touchscreens, microphones) with accompanying software (e.g., speech-to-text software) and/or display devices (e.g., monitors, touchscreens, projectors (e.g., 2-D, 3-D, and/or holographic projectors).

In embodiments, any function attributed to any module described herein may be performed wholly or in part by one or more other modules. A module may access a third party system or server to perform the ascribed functions.

Social media server 300 may support one or more program products that can be computer applications or other types of computer-readable code. Such computer applications or computer-readable code can be configured for use, for example, on a Windows-based, iOS-based, Linux-based, or Android-based computer operating system. Accordingly, such computer applications or computer-readable code may include various instructions, rules, and/or conditions that can be stored on a non-transitory computer-readable medium (e.g., non-transitory memory storage device 302) to be read by the one or processors 304 to carry out the various functions of the social media server 300.

Social media server 300 includes a subscriber storage module 306 which may store data associated with information relating to one or more users associated with one or more subscriber devices (e.g., subscriber devices 101a, 101b, 101c . . . 101n; 102a, 102b, 102c . . . 102n; 103a, 103b, 103c . . . 103n). Such information can include, for example, names, ages, birthdates, interests, hobbies, school information (such as course of study, graduation date, and/or course of study), employment information, and/or group membership. Subscriber storage module 306 can contain data associated with one or more users having an account or profile registered with a program product hosted on social media server 300. Subscriber storage module 306 can contain data associated with one or more users having an account or profile registered with a program product not hosted on social media server 300, e.g., a third-party social media server, for example, Facebook, LinkedIn, Instagram, Tinder, and/or Grindr.

Social media server 300 includes a user group data storage module 308 which can store information relating to one or more of user groups 100a, 100b, 100c . . . 100n, for example, user group history information, user group status information (for example, open, closed, active, inactive, etc.), and/or user group demographic information which may be aggregate and/or averaged data associated with, for example, user group member ages, user group interests, user group member genders, and/or user group member locations.

Social media server 300 also includes a matching module 310 that is configured to associate at least one data set stored on user group storage module 308 with at least one other data set stored on user group storage module 308 so that two or more user groups are connected, e.g., via an alert, notification, and/or communication across social media server 300. In embodiments, data sets associated with different user groups may relate to criteria such as age, gender, location, demographic information and/or interests, to name a few. User groups can designate certain criteria by which matching module 310 chooses such criteria, for example, through a filter or other customizable function as described further herein.

Matching module 310 can be configured to associate at least one data set stored on subscriber storage module 306 with at least one data set stored on user group storage module 308. For example, when an individual subscriber or user may be compatible for membership with one or more user group, an administrator of one or more user groups may be provided with the option to accept (or alternatively reject or forgo) the individual subscriber or user into his or her user group.

Accordingly, social media server 300 includes a communication module 312 to facilitate communication between two or more user groups across social media server 300. As described above, communication module 312 facilitates communication between two or more user groups upon a determination made by matching module 310 of one or more matches of data sets associated with two or more of user groups 100a, 100b, 100c . . . 100n. Communication module 312 can be configured to only facilitate communication between mutually interested user groups and/or individual users, e.g., user groups and/or individual users who have consented through an affirmative communication with social media server 300 that they wish to have further interaction with the other user groups and/or individual users. Communication module 312 can be configured to facilitate communication between two or more user groups if only one interested user group is present.

Social media server 300 may include an API module 314 configured to provide one or more application programming interfaces (APIs) for interaction with a server or program product external to social media server 300. In this regard, API module 314 can be configured to communicate with one or more APIs provided with a third party service. API module 314 may provide for interactive functionality with a server or program product, e.g., through one or more embedded media content displays or players, icons or graphics, and/or notification fields, to name a few. API module 314 can be configured to retrieve, e.g., pull, data associated with subscribers or user groups from a pre-populated third party media server, for example, Facebook, LinkedIn, Instagram, Tinder, and/or Grindr. API module 314 may be configured to publish, e.g., push, data associated with ongoing activity of social media network to a third party service.

Social media server 300 may include an authentication module 316 for verifying the identity and/or permissions associated with a user attempting to access one or more portions of social media network 300. Authentication module 316 can store data such as login credentials (e.g., usernames, passwords, and/or challenge questions), data keys, or other types of data verification that may be associated with, for example, an account of users and/or groups for a program product hosted on a portion of social media server 300. Authentication module 316 may employ different types of authentication protocols, to verify the identity and/or permissions associated with one or more users and/or groups accessing portions of social media server 300, for example, cryptographic keys, external security devices, and/or challenge questions.

Social media server 300 may include a commercial content module 318 that provides content of a commercial nature to one or more subscriber devices. Such content may be, for example, text-based, graphic-based, and/or audio-based media content that describes, promotes, and/or offers for sale a good and/or service. Commercial content module 318 can be configured to communicate with one or more third-party commercial content advertisers, for example, vendors, restaurants, bars, lounges, concert venues, movie theaters, and/or bowling alleys, to name a few. Commercial content module 318 can be configured to transmit commercial content to users within the same geographic region and/or geographic location as a good and/or service being offered. Commercial content module 318 can filter content transmitted to the one or more subscriber devices by matching data associated with content being transmitted that is associated with goods and/or services with data provided by location module 114 of the respective subscriber devices. For example, one or more users passing within a predetermined radius of a participating business and/or service provider may receive an alert and/or notification from social media server 300 relating to commercial content associated with the participating business and/or service provider. Such commercial content may be tailored to the size and or demographic of a user group, for example, offers for coupons, vouchers, and/or discounts for goods and/or services. In embodiments, such offers may be designated “crew cuts.”

Commercial content module 318 can also be configured to transmit commercial content to users and/or user groups passing viewing distance of an electronic display, for example, an electronic billboard, television unit, computer monitor, or other display unit. Proximity to an electronic display may be determined by commercial content module 318, for example, by correlating location data from one or more electronic devices associated with users (e.g., data from location module 114 of subscriber device 100) with position data of the electronic display.

For example, a user or group of users may walk by an electronic billboard. Upon detection of the proximity of one or more of the users to the electronic billboard, commercial content module 318 can cause targeted commercial content to display on the electronic billboard based on one or more factors associated with the user or group of users. In this regard, commercial content module 318 can be configured to cause a physical action, e.g., a change in displayed content, on a physical device. Such a configuration can provide third-party advertisers with the ability to direct more targeted advertisements or offers for sale to consumers as compared to an electronic display with a randomized or serialized catalogue of commercial content for display.

In the instance of a user group, commercial content module 318 may transmit data associated with a most relevant unit of commercial content following a determination made through an applied algorithm, for example a raw or weighted average of factors associated with individual user members of a user group. Such factors can include prior purchases and/or indicated interests (e.g., viewing of advertisements and/or click-through of weblinks) by one or more individual users and/or a user group as a whole.

Commercial content module 318 can also be configured to supplement commercial advertisement and/or commercial offer content with commercial content related to options for further research and/or purchase of goods or services that have been displayed to one or more users. For example, commercial content module 318 can provide weblinks or other electronic pathways for a user to attain additional information and/or purchase a good or service that has been advertised or offered for sale through content provided by commercial content module 318.

Social media server 300 can include a group payment module 320 that is configured to apply one or more partial payments for a good and/or service from multiple individual users that are part of one or more of user groups. Accordingly, group payment module 320 can be configured to apply an electronic payment, for example, a debit or credit payment, from one or more user groups to a good and/or service, for example, a good and/or service advertised through commercial content module 318. In this regard, group payment module 320 can be configured to split a monetary value or amount of an electronic payment among multiple users of a user group 100a, 100b, 100c . . . 100n, and can be configured to apply such electronic payment in coordination with a third party electronic payment service, for example, through an API associated with a third party electronic payment service. Group payment module 320 may be configured to apply an algorithm to a group of users or subscribers making an electronic payment across social media server 300, for example, an algorithm that divides a monetary amount or value by the number of users involved in the payment transaction.

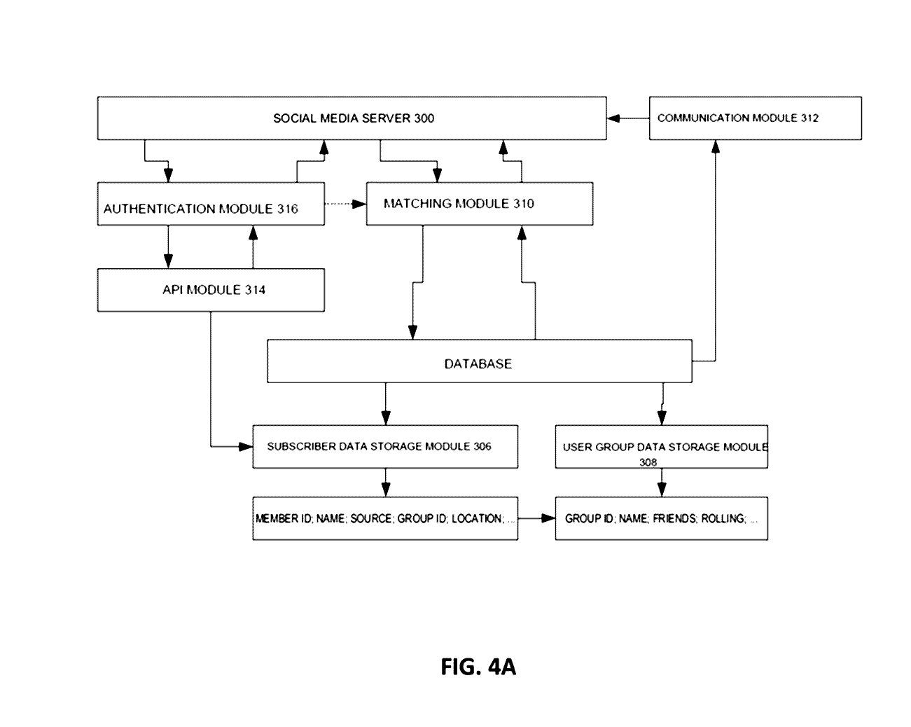

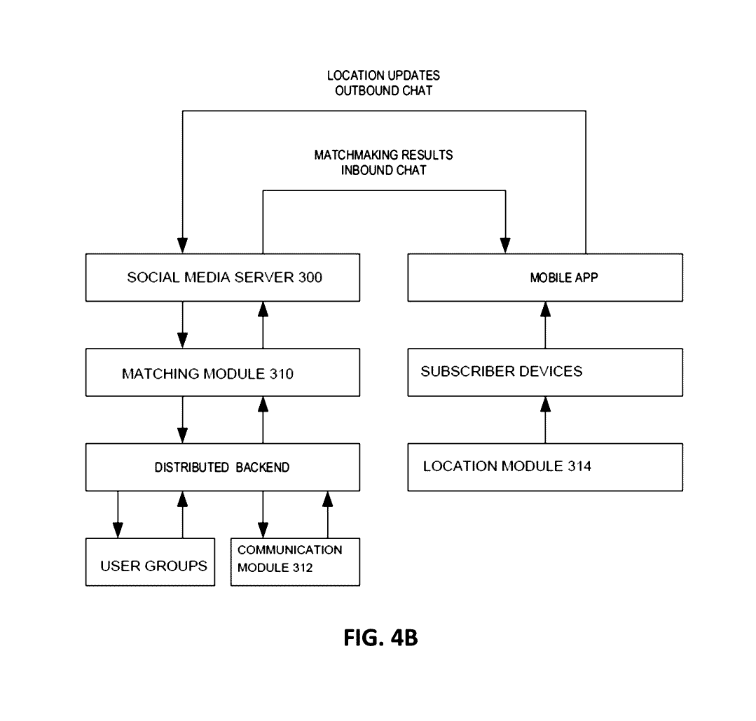

Still referring to FIG. 1, FIG. 2, and FIG. 3, and turning now to FIG. 4A, a schematic diagram of a configuration of a portion of social media network 1000 is shown according to an exemplary embodiment of the present invention, with various components of social media server 300 interconnected across data network 400. For example, social media server 300 includes authentication module 316 which can access with a third party service (e.g., Facebook, LinkedIn, Instagram, Tinder, and/or Grindr) via API module 314, as shown. In this regard, subscriber data storage module 306 and user group data storage module 308, as shown, may be populated with information via data provided by a third party service through API module 314, as shown. Such data may be stored on separate and/or combined databases associated with social media server 300. Such a database may be accessed, for example, by matching module 310 in making determinations as to whether user groups are compatible for further interactions across social media network 1000. As shown, social media server 300 may include or be associated with communication module 312 to facilitate such communications among user groups.

Referring additionally to FIG. 4B, another schematic diagram of a configuration of a portion of social media network 1000 is shown according to an exemplary embodiment of the present invention. As shown, communication between user groups via communication module 312 may occur via an interface made available to individual users through a program product, e.g., a mobile or other computer hardware-supported application associated with social media server 300, for example, a graphic user interface (GUI) for display on a respective subscriber device 100 of one or more users. Such a computer application may connect with other user groups upon one or more determinations made by matching algorithm 310 supported on social media server 300. Such a computer application can employ data retrieved from a location module 114 of a respective subscriber device 100, as shown.

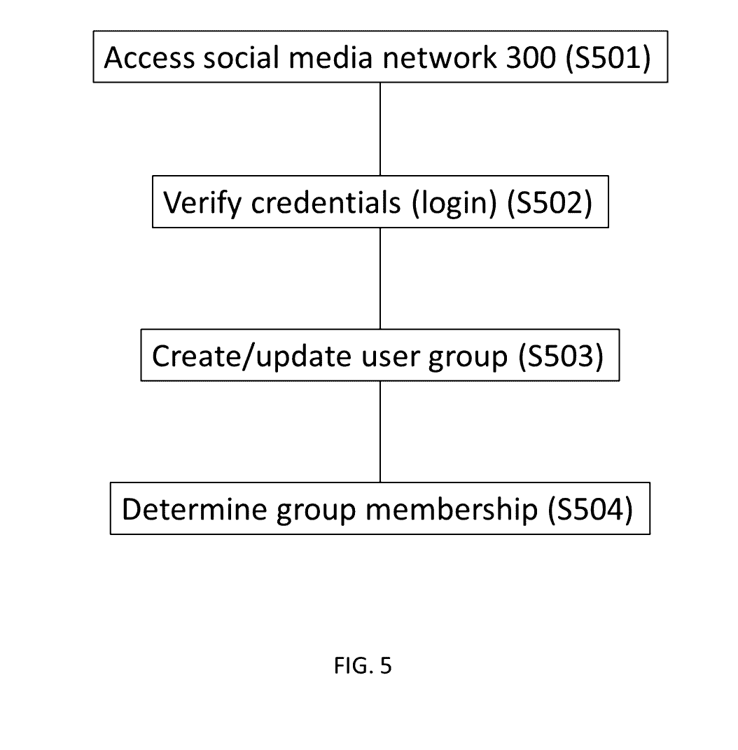

With reference to FIG. 5A, a flow diagram indicating steps involved in configuring product program 310 for use by a user group is shown according to an exemplary embodiment of the present disclosure. A representative user, such as an administrator or proxy, of a user group may implement the steps described herein via a subscriber device. Accordingly, the representative user of the user group may make decisions, change settings, and make configurations to product program 310 that affect other members of the user group. In this regard, the user group may designate the representative user, for example, by a majority vote of the members of the user group. Alternatively, more than one representative user, for example, a plurality of members of a user group such as all the members of a user group, may be able to implement the steps described herein. Such a representative user may be designated as a “founder” of a user group.

In a first step S501, a representative user accesses social media network 1000, for example, through a computer application or other electronic portal supported by social media server 300. Accessing social media server 300 may comprise executing a computer-readable application or command string on a subscriber device, for example, selecting, clicking, or tapping an associated icon.

In a second step S502, verification of the representative user's identity, membership within a user group, and/or subscription to a product or service supported on social media server 300 is performed. Such verification may take the form of an entered password or passcode, PIN, or other method of data entry compared to data values stored in authentication module 316.

In a third step S503, the representative user may define the user group. In the case of an already-existing user group, a representative may alternatively update information regarding the user group in this step. Such information may include, for example, a user group name, a user group description, a user group status, and/or media associated with the user group (such as audio, video, and/or still photos).

In a fourth step S504, the representative user can add or remove users from the user group. Such addition or removal or users may not be a unilateral decision made by the representative user, but rather can be made by vote of at least a portion of the user group.

In exemplary embodiments, and as described further herein, information relating to user groups, for example, user group biographical information, user group membership, user group media content, and/or user group activity information, can be stored for later retrieval on a portion of social media network 1000 or on a separate network. In this regard, user groups can establish a non-ephemeral presence, for example, for self-promotion, recruiting, and/or commercial purposes, to name a few. Accordingly, each member of a user group may have access and/or control over content related to the user group. In this regard, user groups may participate in activities externally of social media network 1000, for example, online multiplayer games, and/or crowdfunding events.

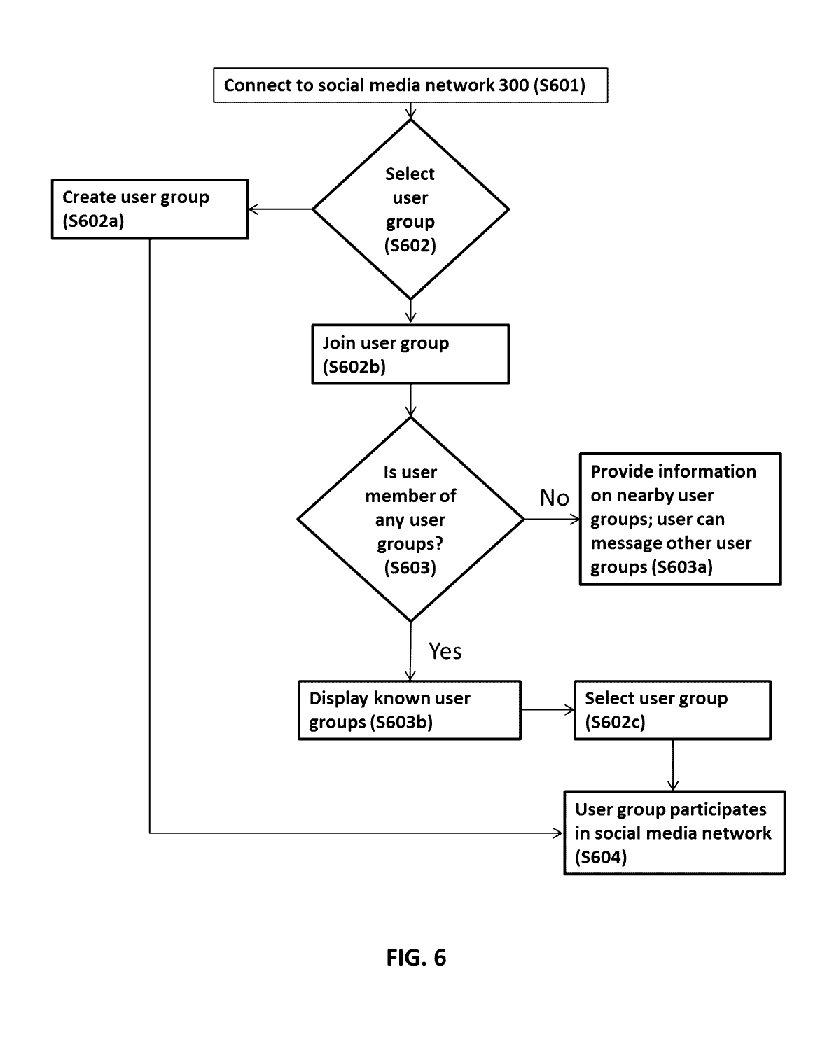

Still referring to FIG. 1, FIG. 2, and FIG. 3, and with additional reference to FIG. 6, a flow chart relating to use of social media network 1000 from the perspective of a representative user is illustrated. In a first step, a user initiates connects to social media network 1000, e.g., via a computer program application or other electronic portal supported on social media server 300 (S601).

In a step S602, a user is then prompted to either join a user group (S602b), or create a new user group (S602a). If the user chooses and successfully creates a new user group as in step S602a, the user and his or her user group may proceed to participate in activities across social media network 1000 supported by social media server 300.

If the user chooses to join a user group, social media server may detect if the user is already associated with any user groups (S603).

If the user is not already associated with any user groups, social media server 300 may then provide the user with information on nearby user groups in his or her general geographic region (S603a) and an option to contact and/or join those user groups.

If, however, the user is already associated with any user groups, social media server 300 may provide, through one or more graphic user interfaces, information relating to these user groups (S603b). It will be understood that a user may be presented with a user group that he or she is associated with as well as having the option to view and/or join other nearby user groups. In embodiments, a user may join a group that is not within his or her geographic region and/or geographic location. In a step S603c, a user can then select a user group to join.

If, however, at least one other member of the user's chosen user group is nearby, the user can then join the user group and proceed to participate in user group activities on social media network 1000 (S604).

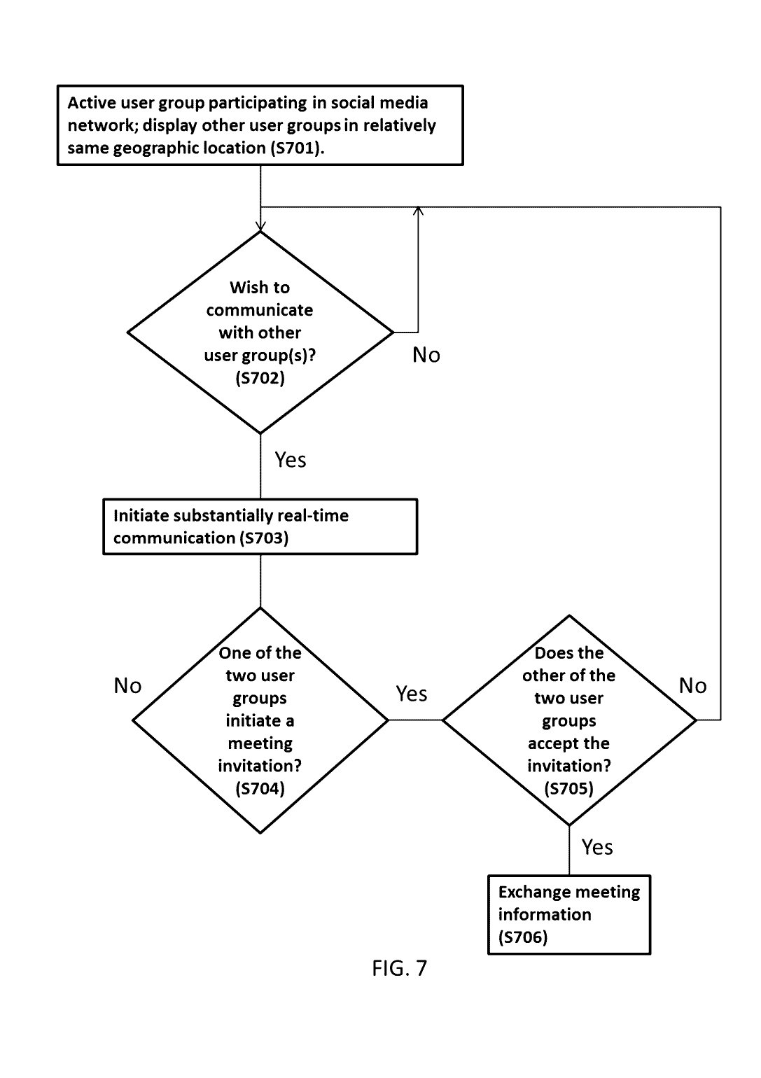

Still referring to FIG. 1, FIG. 2, FIG. 3, and with additional reference to FIG. 7, a flow chart of processes occurring across social media network 1000 is illustrated according to an exemplary embodiment of the present invention.

In a first step, a user group is formed and actively participating in social media network 1000 (S701) as described above in FIG. 6. Active participation of an already-formed user group is sometimes referred to herein as “rolling.” The user group is then presented with the option to communicate with other user groups (S702a). If the user group chooses not to interact with any other user groups, the process may end or pause until such time as the user group opts to interact with another user group. In the meantime, the user group may utilize other functionality of social media network 1000, for example, updating the biographical information of the user group.

If, however, the user group chooses to interact with another user group, a process of social media server 300 may be initiated to begin a substantially real-time communication session with another user group (S703), e.g., via communication module 312. The substantially real-time communication may be limited in scope and/or duration by one or more limiting conditions, for example, a maximum allotted time before the communication session is automatically terminated and/or a pre-determined number of communications that may be exchanged, for example, 2, 3, 4, 5, or 6, communications alternating between the two user groups. A pre-determined number of communications that are exchanged between two user groups may be associated with the revelation of a previously-unavailable piece of information about the respective user groups, for example, user group member names, user group member ages, user group interests, and/or user group history.

During the substantially real-time communication session, one or more individual members of either of the two user groups has the option to initiate a physical meeting invitation (S704). If no physical meeting invitation is extended between the two user groups, the process may revert to step 702.

If, however, one of the two user groups extends a meeting invitation, the other of the two user groups has the option to accept the meeting invitation (S705). If the receiving user group chooses to accept the meeting invitation, specific data relating to the physical locations of the user groups may be provided by social media server 300 (S706). Such specific data may be in the form of, for example, a visual map, GPS coordinates, and/or a landmark, to name a few. If the receiving user group does not accept the meeting invitation, however, the process may end or revert to step S702.

It will be understood that social media server 300 may be devoid of a substantially real-time communication feature, and may instead provide user groups with the ability to spontaneously extent, accept, and/or reject an invitation to a physical meeting in the manner described above.

It will be understood that the social media network, program products, and associated methods described herein may present the potential for the marketing of commercial goods and services to groups of users bundled into specific demographics by virtue of their association with various user groups.

For example, information exchanged through social media server 300 may be utilized by third-party vendors to target advertisement materials to user groups based on, for example, user group composition and/or user group history, to name a few. In this manner, social media network 1000 may be configured to compile information relating to past, present, and/or future activity of user groups that can define metrics and predictors for use in the formulation and transmission or marketing and advertising content. For example, third-party vendors may choose to offer group-based offers and discounts based upon information provided by the activities of user groups on social media network 1000. In this regard, vendors that purvey related or connected goods and/or services may associate to offer packages of goods and/or services at discounted rates based upon information provided by the activities of user groups on social media network 1000. Groups of merchants and/or vendors associated in such a manner may be sometimes be labeled “guilds.”

In embodiments, portions of media server 300 described above may be accessed by one or more subscriber devices (e.g., subscriber devices 101a, 101b, 101c . . . 100n; 102a, 102b, 102c . . . 102n; 103a, 103b, 103c . . . 103n) through an electronic portal such as the world wide web and/or via a program product configured for use with one or more subscriber devices. A program product may include software or other compute code stored on one or more non-transitory memory storage devices (e.g., non-transitory memory storage device 302) and executable by one or more processors (e.g., processor 304). Such program products may be configured for use on a Windows-based, iOS-based, Android-based, or Linux-based operating system, to name a few. Program products described herein can include one or more graphic user interfaces (GUIs) through which data associated with social media server 300 is displayed and/or projected in a format detectable by one or more human operators of subscriber devices connected across social media network 1000. In embodiments, GUIs of a program product can provide a control interface to a user or subscriber to input commands across social media server 300, e.g., through a hardware device such as a keyboard, mouse, trackball, sensor pad, microphone, motion-capture device and/or capacitive touchscreen, to name a few.

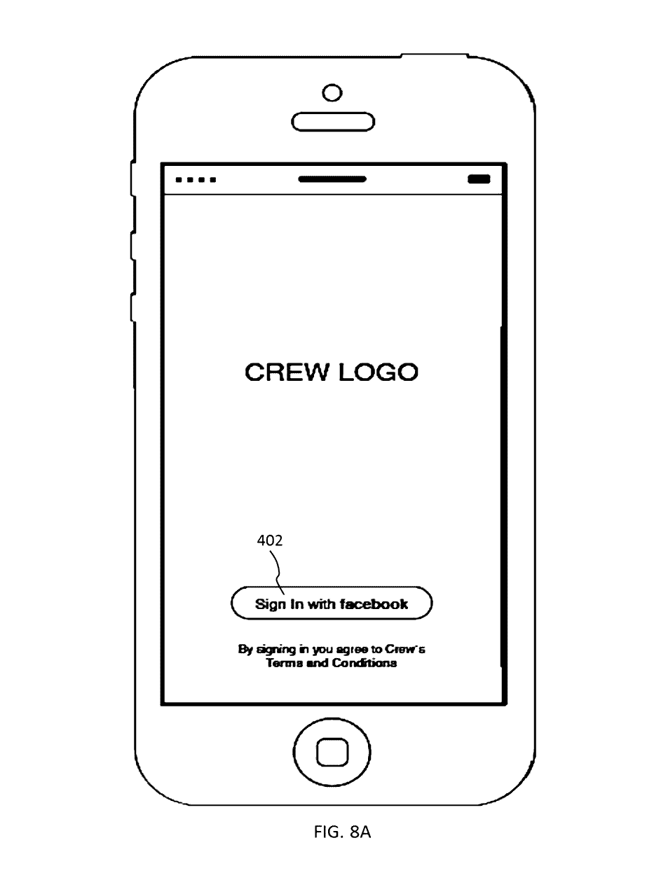

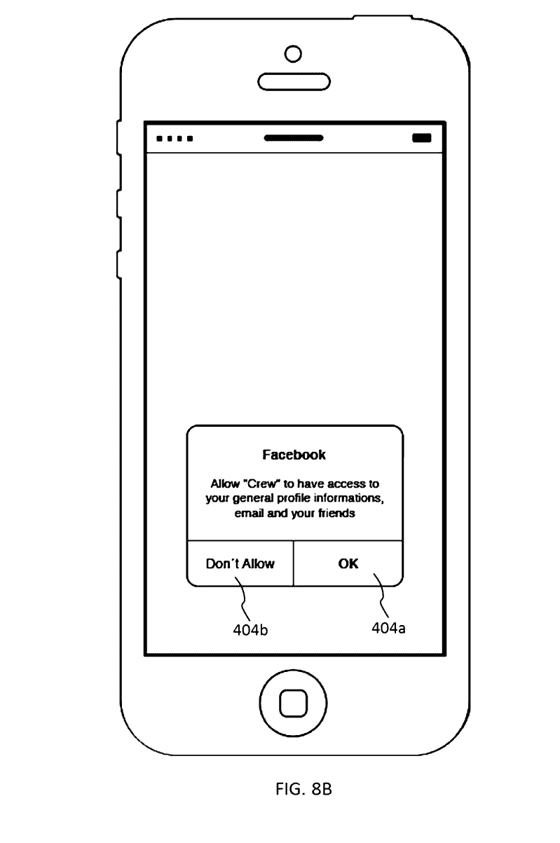

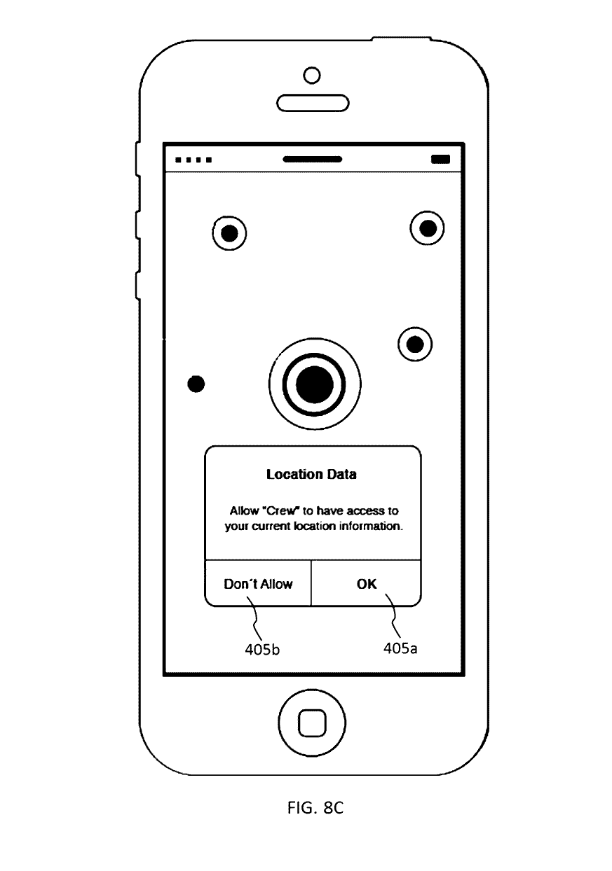

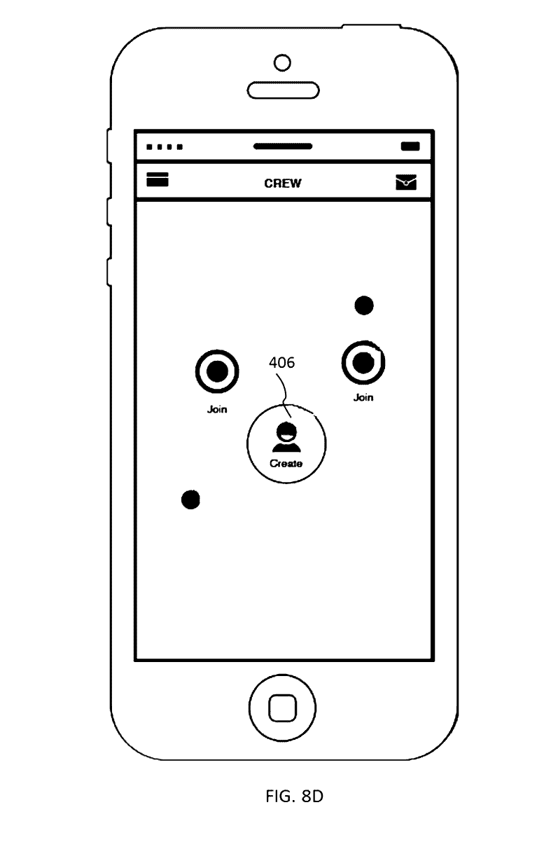

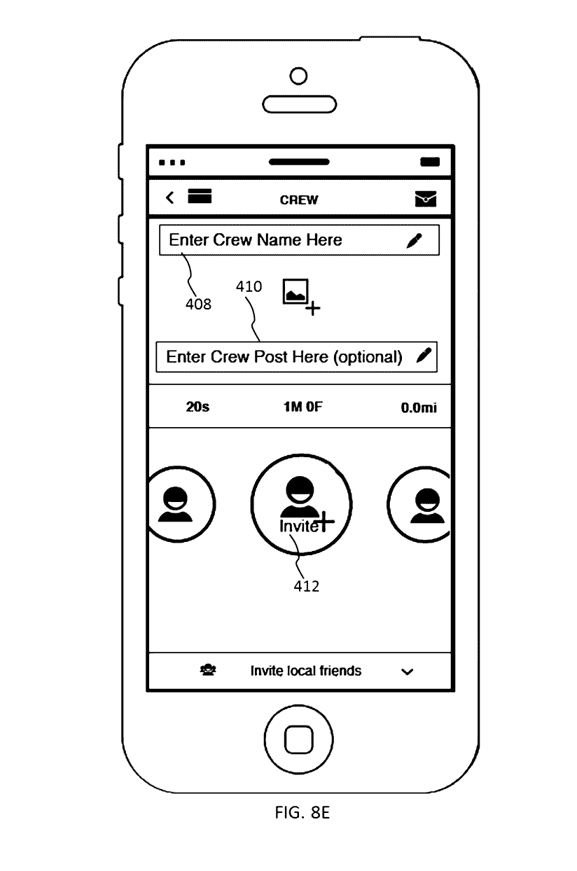

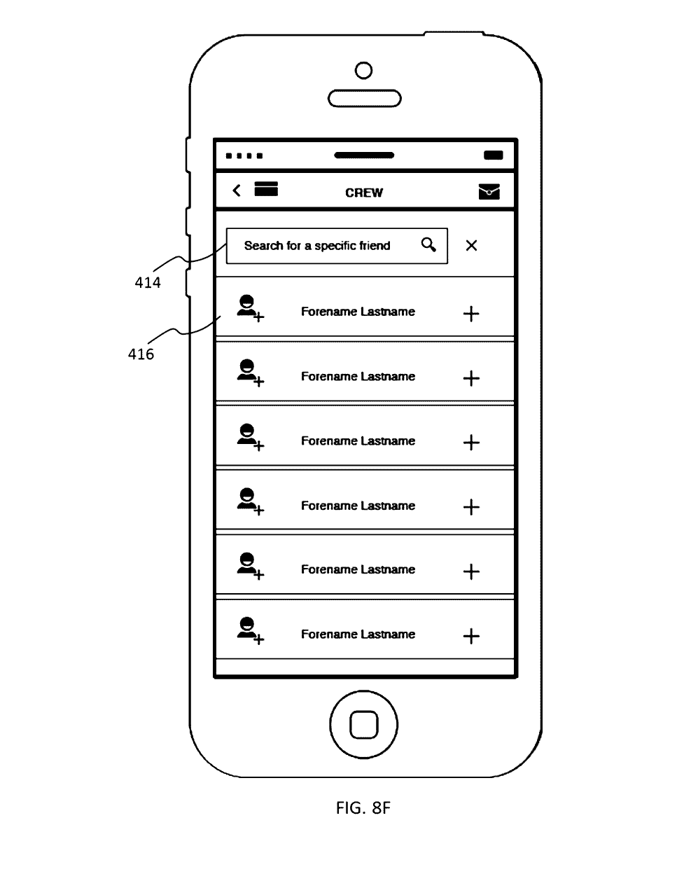

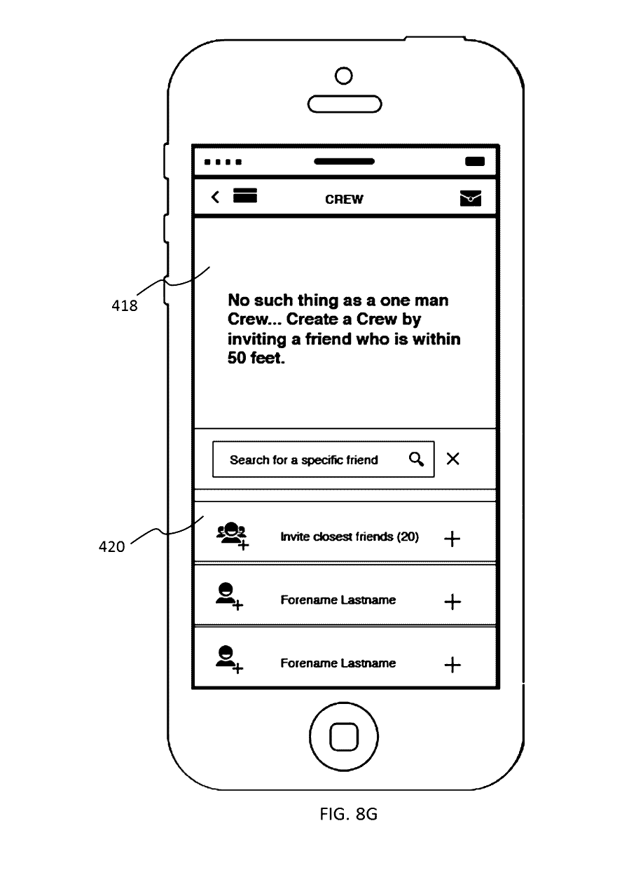

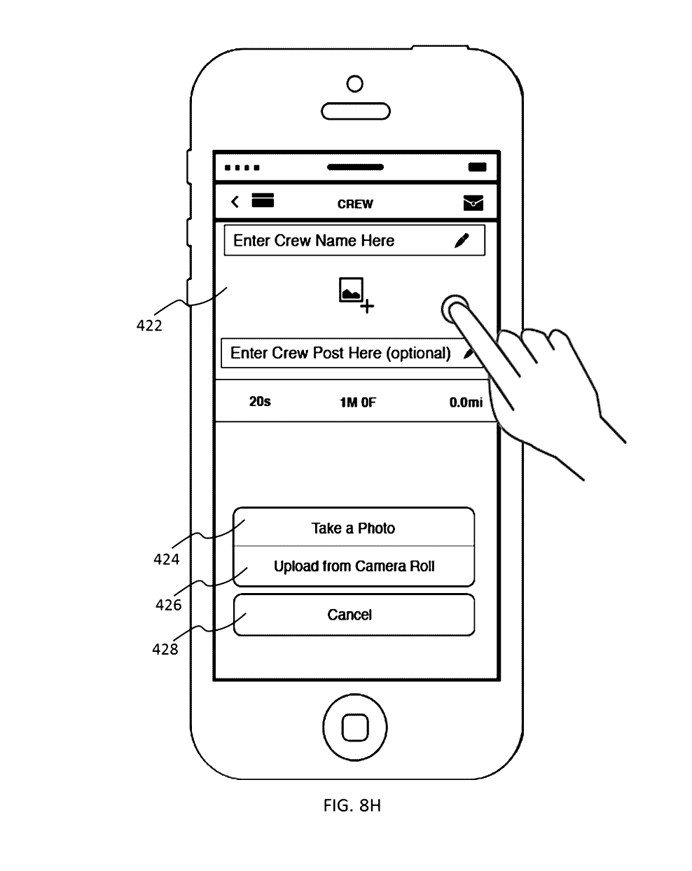

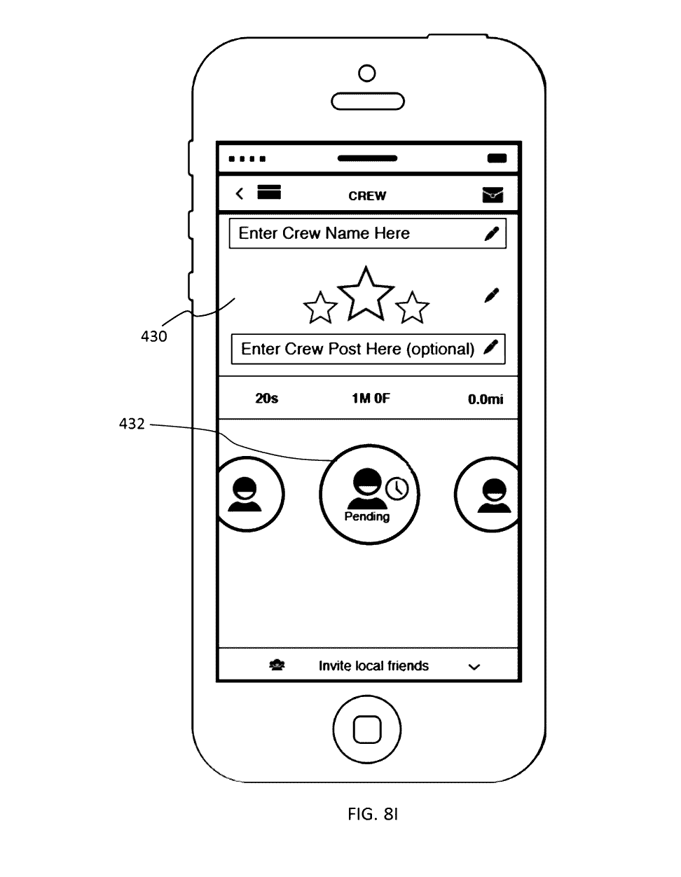

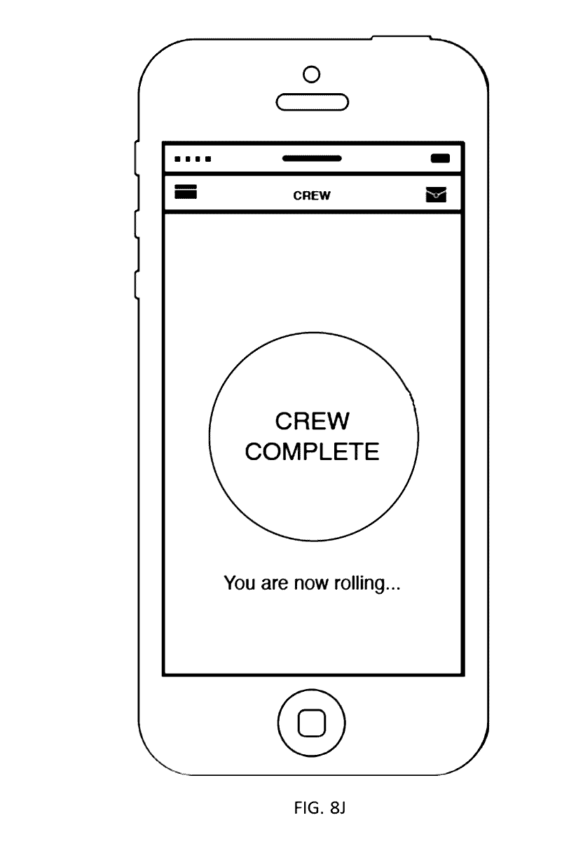

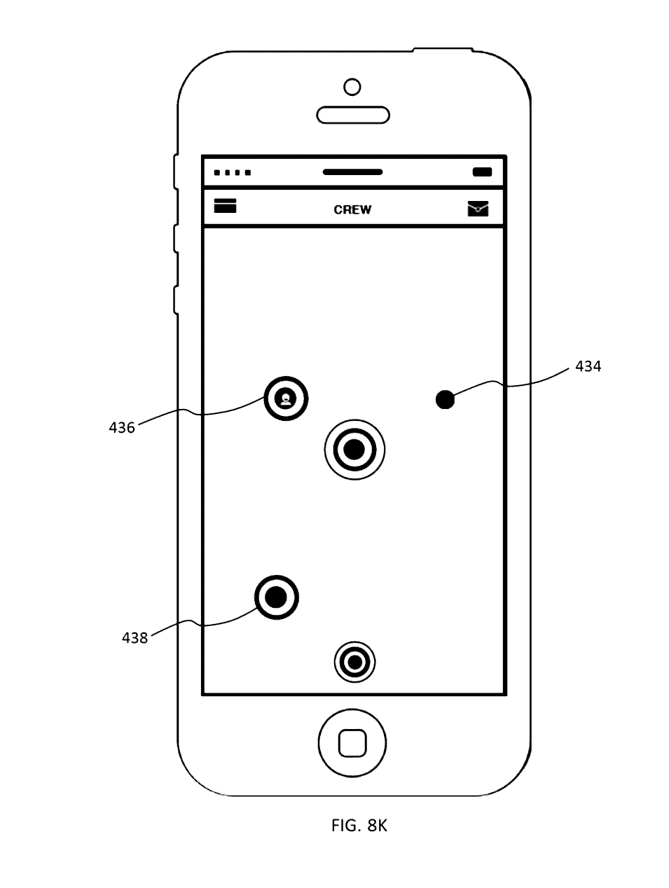

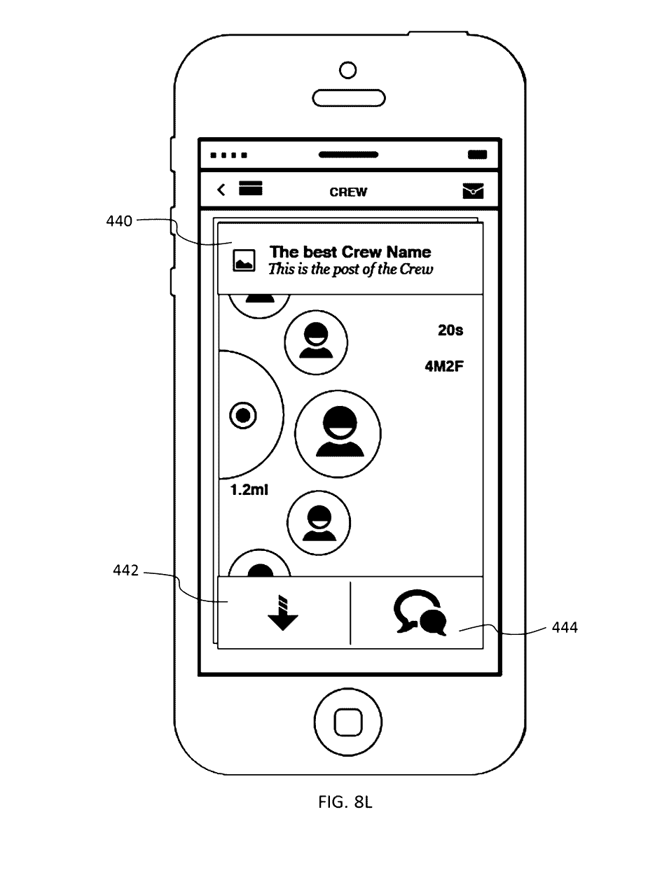

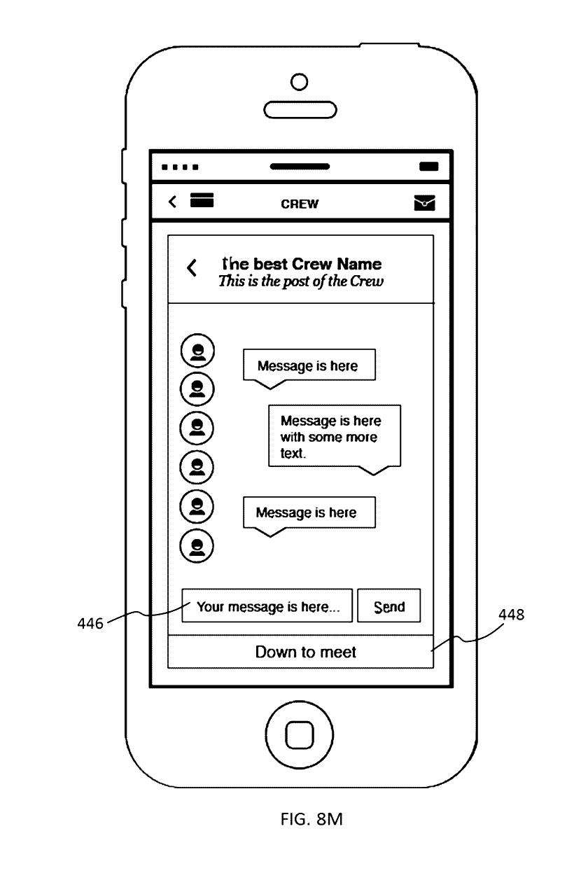

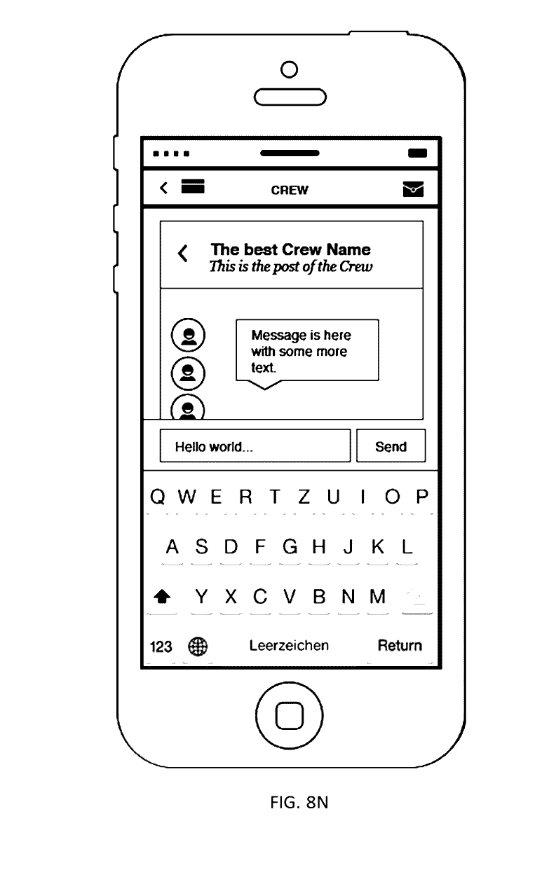

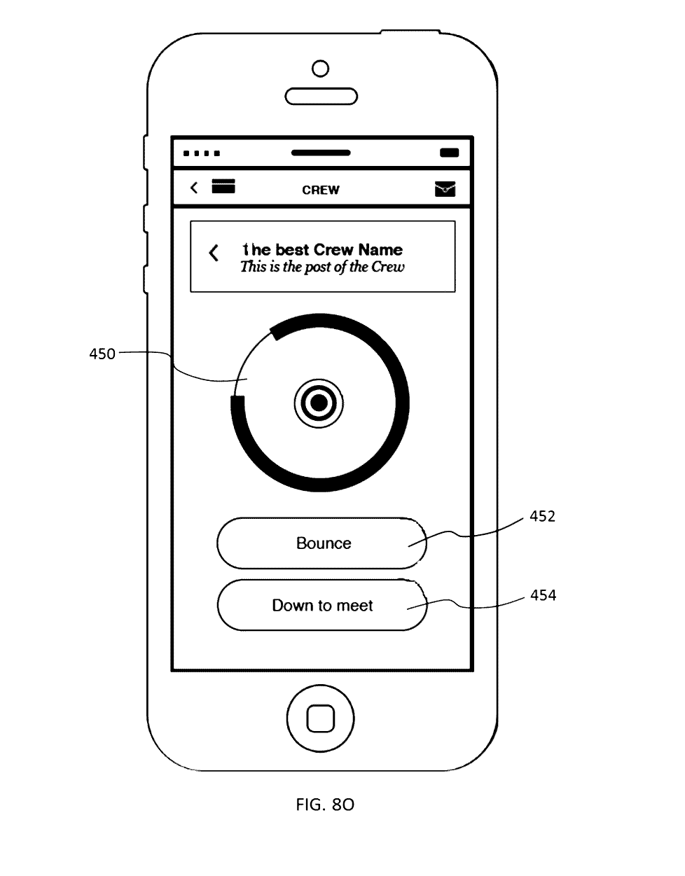

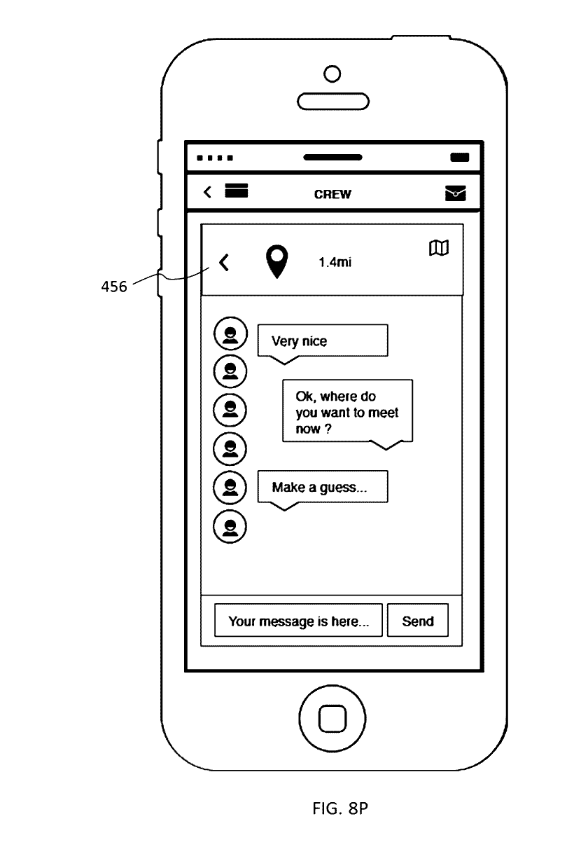

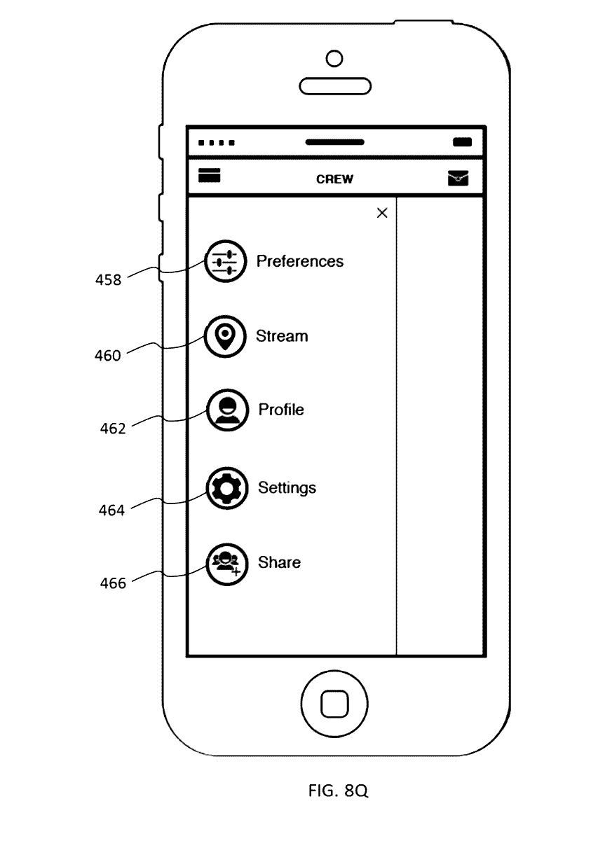

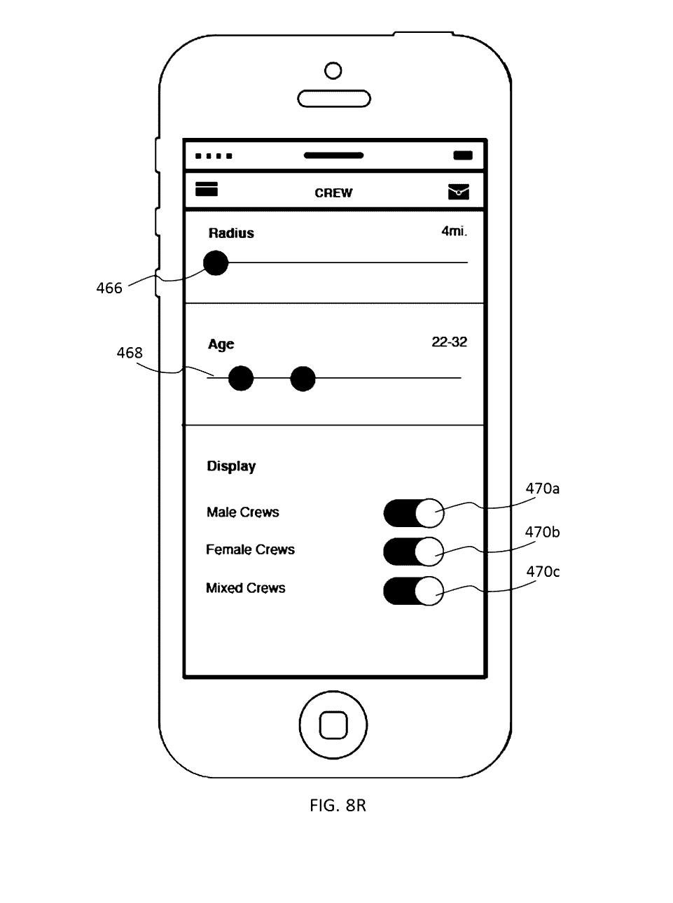

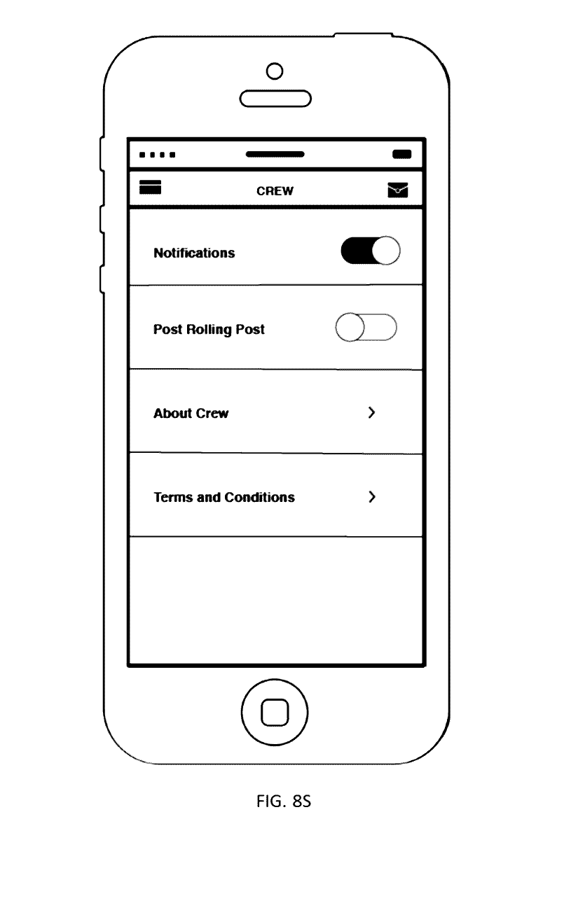

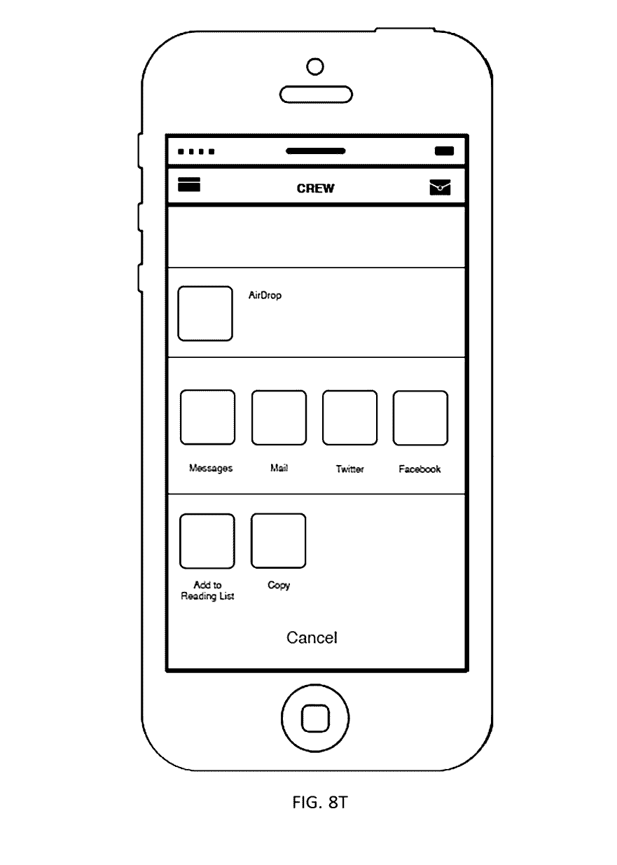

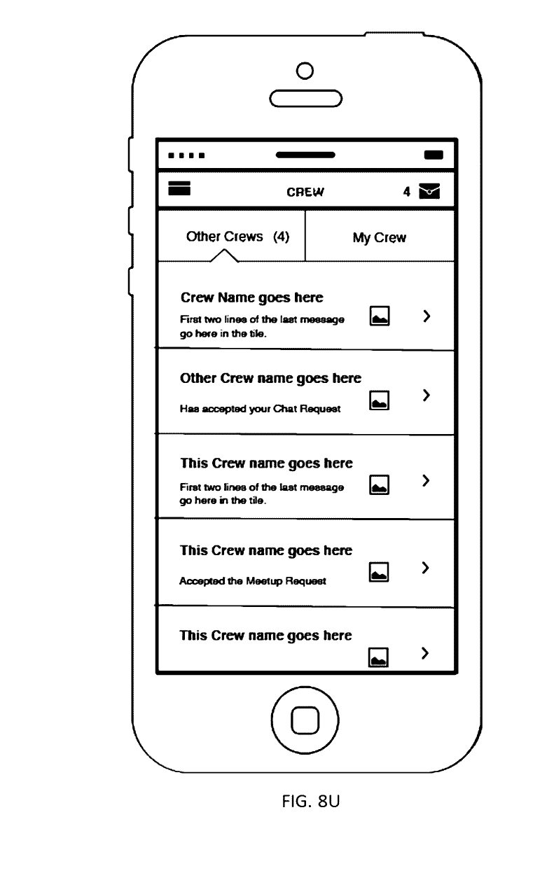

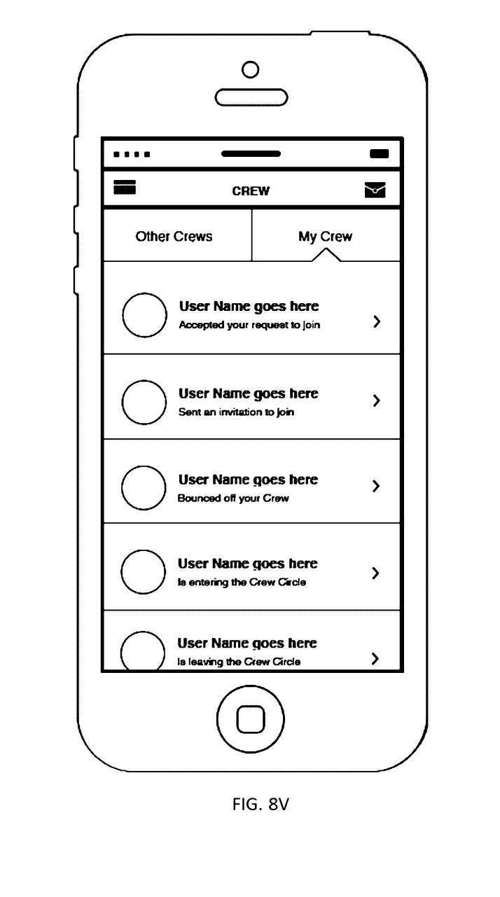

Still referring to FIG. 1, FIG. 2, and FIG. 3, and referring additionally to FIG. 8A, an exemplary GUI of a program product associated with social media server 300 is shown. GUIs associated with an initial or startup function of a program product associated with social media server 300 may display characteristic information related to a program product associated with social media server 300 or an owner entity thereof, for example “Crew”. Such GUIs may include an icon 402 to facilitate connection with a third party service, e.g., via an API or embedded program element. Selection of such an icon 402 may prompt a user for login information relating to a third party service, for example a third party social media network such as Facebook, LinkedIn, Instagram, Tinder, or Grindr, to name a few. Such an action may cause API module 314 to communicate with a third party service. Referring additionally to FIG. 8B, a user may thereafter be prompted to allow connectivity between the program product supported by social media server 300 and the third party service, for example, through a confirmation icon 404a and/or a denial icon 404b.

Referring additionally to FIG. 8C, a GUI of a program product associated with social media server 300 is shown, and may prompt a user, for example, through a confirmation icon 405a and/or a denial icon 405b, to allow communication between social media server 300 and location module 114 of his or her respective subscriber device 100. In this regard, a user may communicate information specific to a geographic region and/or geographic location in which he or she is located with social media server 300.

Still referring to FIG. 1, FIG. 2, and FIG. 3, and referring additionally to FIG. 8D, another exemplary GUI of a program product associated with social media server 300 is shown, and may provide a user with an interface through which he or she may create a user group while visualizing other elements associated with social media network 1000 within his or her geographic region and/or geographic location. For example, an icon 406 may be provided to prompt a user to open a dialogue, field, or page through which one or more criteria related to the creation of a user group can be entered, as described further herein. Other elements associated with social media network 1000 shown on such a GUI may include, for example, representations of other user groups, subscriber devices, and/or businesses, to name a few. In embodiments, concentrations of user groups and/or individual users, events, and/or other elements of social media network 1000 may be denoted with relative visual representations, e.g., meters or scales, differently-sized icons, and/or color coded icons (such as in a thermal representation by concentration of elements).

In embodiments, a GUI of a program product associated with social media server 300 may provide a 3D representation of a geographic region or geographic location to a user illustrating the relative location of elements associated with social media network 1000 as described above. In such embodiments, a photographic, video-based, and/or rendered view of a location can be provided with additional information overlaid upon people, objects, and/or structures, e.g., an augmented reality view of a geographic region and/or geographic location providing information relating to elements of social media network 1000.

Referring additionally to FIG. 8E, another exemplary GUI of a program product associated with social media server 300 is shown, and can provide a user with a customizable field 408, e.g., a text entry field, in which a name or label associated with a user group can be entered for future identification on social media server 300. An additional customizable field 410 can be provided in which a description or message associated with a user group can be entered for future identification on social media server 300. Additional icons 412 can be provided such that, when selected, icons 412 prompt a user to invite other individuals or subscribers to join a user group.

Referring additionally to FIG. 8F, another exemplary GUI of a program product associated with social media server 300 is shown, and can provide a user with a search field 414, e.g. a text field, within which a user can enter the names or partial names of other users or subscribers associated with social media server 300, e.g., users or subscribers having a registered account with social media server 300, for location by social media server 300 in, for example, subscriber data storage module 306 and/or user group data storage module 308. In embodiments, such names or partial names may be natural, e.g., legal or given names, or usernames associated with accounts registered with social media server 300. One or more customizable fields 416, e.g., text entry fields, can be provided within which a user may enter the names or partial names of other users or subscribers associated with social media server 300. Referring additionally to FIG. 8G, an embedded map image 418 illustrating the relative locations of other individuals eligible to be added or invited to a user group may be provided. An icon 420 may be provided which, when selected can add or invite a preselected group of users or subscribers to join a user group. In embodiments, such a preselected group of users or subscribers may be a group of individuals associated with a label or status, e.g. close friends, classmates, family members, etc., or may be a group of individuals compiled by social media server 300, for example, frequent contacts or nearby individuals.

Still referring to FIG. 1, FIG. 2, and FIG. 3, and turning additionally to FIG. 8H, a GUI associated with a program product supported by social media server 300 can provide a user with an icon 422 that prompts the user to access one or more units of media content (e.g., photos, videos, and/or sounds) for association with a user group, e.g., a wallpaper or banner. An icon 424 may be provided which, when selected by the user, may access a hardware and/or software element of subscriber device 100, for example, an image capture module such as a camera device. An icon 426 may be provided which, when selected by the user, may access a library of media content stored on subscriber device 100 (e.g., on data store 302). An icon 428 may be provided which, when selected by the user, cancels the prompt to access one or more units of media content for association with the user group, e.g., a cancel or back button.

Referring additionally to FIG. 8I a GUI associated with a program product supported by social media server 300 can display status information relating to the user group. For example, such as GUI may display a unit of media content 430 associated with the user group. One or more icons 432 may be provided that indicate a status of one or more invitations of other users or subscribers to join a user group.

Referring additionally to FIG. 8J, a GUI associated with a program product supported by social media server 300 can be provided and display a logo, graphic, icon, or confirmation upon the successful formation of a user group, as shown. The successful formation of a user group may occur upon the acceptance of an invitation or joining of two members or subscribers to the user group.

Still referring to FIG. 1, FIG. 2, and FIG. 3, and turning additionally to FIG. 8K, a GUI associated with a program product supported by social media server 300 can provide a user with a map view of a geographic region and/or geographic location in which he or she is located and other user groups that are located within the same geographic region and/or geographic location. An icon 434 can be provided that indicates a user group having no association with the user group of which the user is a member. An icon 436 can be provided that indicates a user group that has a common factor with the user group of which the user is a member, for example, the other user group may include an individual who is known to the user through a third party social media network, attended the same school, or have similar interests, to name a few. An icon 438 can be provided that indicates an ongoing social activity or function, which may be another user group, or may be an ongoing event, for example, a scavenger hunt, open bar, promotion, or concert, to name a few. Such icons 438 may be designated “beacons” by which a user group may identify activities to partake in.

Referring additionally to FIG. 8L, a GUI associated with a program product supported by social media server 300 can provide a user with detailed information on another user group upon selection of an icon associated with that user group. As shown, this information may include a description field 440, which may include text and/or graphics that describe the user group. Additional information relating to a particular user group may be displayed on such a GUI, for example, a current distance of the selected user group away from the user, and/or the size and/or composition of the selected user group (e.g., number of male and female individual members). Nearby user groups may be presented in a scrolling, swiping, or otherwise queued style so that a user can browse detailed information on user groups in this manner. As shown, an icon 442 may be provided that allows a user to remove a particular user group from view. Such a feature may be designated as “bouncing” another user group. An icon 444 can be provided that allows a user to initiate a realtime or substantially realtime conversation with a selected user group or individual member thereof. Such a realtime conversation can be a text-based chat supported by communication module 312.

Referring additionally to FIGS. 8M and 8N, a GUI of a program product supported on social media server 300 is shown providing a user with a substantially realtime communication interface through which a user can send communications, e.g., text-based, graphic-based, or audio-based communications to one or more individual members of a user group or to the user group as a whole. Accordingly, a message field 446 can be provided for entry of such communication information by the user. An icon 448 can also be provided which, when selected by a user, can initiate instructions or more detailed communications directed toward a physical meeting between the user and his or her user group, and the selected user group.

Still referring to FIG. 1, FIG. 2, and FIG. 3, and referring additionally to FIG. 8O, a GUI of a program product supported on social media server 300 is shown wherein an interactive communication function is bypassed before a decision to meet between a user and associated user group and a selected other user group. Such a GUI can be provided following an intercommunication function as described above. As shown, a map icon 450 may be provided indicating a relative position between two or more communicating user groups. A denial icon 452 may be provided through which a user may opt not to continue communications with the selected user group, e.g., “bounce” the selected user group. In embodiments, a confirmation icon 454 may be provided which, when selected by the user, can initiate instructions or more detailed communications directed toward a physical meeting between the user and his or her user group, and the selected user group.

Referring additionally to FIG. 8P, a GUI of a program product supported on social media server 300 is illustrated displaying information to a user who has decided to further communications with another user group of social media network 1000. Accordingly, a display field 456 can be provided that indicates more detailed information regarding the selected user group, for example, distance from the user and/or his or her user group, e.g., via an embedded map element. As shown, an ongoing substantially realtime communications dialogue may be provided during such a display and/or projection of information.

Still referring to FIG. 1, FIG. 2, and FIG. 3, and turning additionally to FIG. 8Q, a GUI of a program product supported on social media server 300 is shown displaying and/or projecting an options menu through which a user can access additional settings via a preferences icon 458, a stream icon 460 (e.g., a communications dialogue icon), a user profile icon 462, a settings icon 464, and/or a share icon 466 for inviting other users to participate in social media network 1000.

Referring additionally to FIG. 8R, a GUI of a program product supported on social media server 300 is illustrated providing various preferences and/or filters to a user. As shown, a distance icon 466 (which may be a slider bar, as shown) can be provided to a user for designating a geographic region and/or geographic location in which he or she may wish to interact with other user groups. An age icon 468 (which may be a slider bar) may be provided to a user for designating a minimum, maximum, and/or average age of individuals associated with other user groups with which he or she may wish to interact. Gender icons 470a, 470b, 470c may be provided to allow a user to designate a gender demographic of user groups with which he or she may wish to interact.

Referring additionally to FIG. 8S, a GUI of a program product supported on social media server 300 is illustrated providing additional settings through which a user may control functions of a program product, for example, the ability of the program product to “push” notifications to subscriber device 100. Additional information and/or settings can be provided, for example, information about social media network 1000 and/or portions thereof, and terms and conditions associated with participation in social media network 1000.

Referring additionally to FIG. 8T, a GUI of a program product supported on social media server 300 is illustrated providing an interface through which a user may share, e.g., communicate an invitation or notification to a potential user via a third party service, such as a native text messaging and/or electronic mail application, Facebook, LinkedIn, Instagram, Tinder, and/or Grindr.

Referring additionally to FIG. 8U, a GUI of a program product supported on social media server 300 is illustrated providing various notification and/or communication data to a user regarding ongoing activities across social media network 1000. Such notification and/or communication data can relate to, for example, communications between user groups, communications between individual users, communications between user groups and individual users, invitation acceptance notifications, and/or upcoming events, to name a few. Such notifications and/or communications may be parsed between a user group of which the user is a member, and other user groups.

Referring additionally to FIG. 8V, a GUI of a program product supported on social media server 300 is illustrated providing various notifications and/or communications regarding a user group of which the user is a member. Such communication and or notifications can relate to, for example, new members of the user groups, departing members of the user group, and acceptance of invitation to the user group.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

1. A social media server, comprising:
one or more processors;
one or more non-transitory computer-readable memory devices upon which a set of instructions are stored, the one or more non-transitory computer-readable memory devices electronically coupled with the one or more processors to implement at least one instruction of the set of instructions;
a user group data storage module electronically coupled with the one or more non-transitory computer-readable memory devices and including data associated with a plurality of user groups of the social media server, each user group containing a plurality of individual users;
a matching module electronically coupled with the one or more non-transitory computer-readable memory devices and configured to match at least one data set associated with at least one user group of the plurality of user groups with at least one data set associated with at least one other user group of the plurality of user groups; and
a communication module electronically coupled with the one or more non-transitory computer-readable memory devices for providing substantially realtime communication between the at least one user group and the at least one other user group upon a matching by the matching module.

2. The social media server of claim 1, wherein the at least one data set associated with the at least one user group and the at least one data set associated with the at least one other user group correspond to a location of the respective user groups.

3. The social media server of claim 2, wherein each respective location is within a common geographic region.

4. The social media server of claim 1, further comprising a commercial content module electronically coupled with the one or more non-transitory computer-readable memory devices for transmitting data associated with commercial content to one or more electronic devices electronically coupled with the social media server.

5. The social media server of claim 4, wherein the data associated with commercial content is an advertisement for a good or service.

6. The social media server of claim 4, wherein the commercial content module transmits data associated with commercial content to the one or more electronic devices based upon a physical location of the one or more electronic devices.

7. The social media server of claim 4, wherein the commercial content module transmits data associated with commercial content to one or more other electronic devices based on a proximity of the one or more electronic devices to the one or more other electronic devices.

8. The social media server of claim 1, further comprising a group payment module electronically coupled with the one or more non-transitory computer-readable memory devices and configured to apply an electronic payment from one or more user group of the plurality of user groups to a good or service.

9. The social media server of claim 8, wherein the group payment module is configured to divide a total cost of a good or service among a respective plurality of individual users of the one or more user group of the plurality of user groups.

10. The social media server of claim 1, further comprising an application programming interface module electronically coupled with the one or more non-transitory computer-readable memory devices for communicating with one or more third party services external to the social media server.

11. The social media server of claim 10, wherein the application programming interface module is configured to transmit data to the one or more third party services.

12. The social media server of claim 10, wherein the application programming interface module is configured to retrieve data from the one or more third party services.

13. A social media server, comprising:
one or more processors;
one or more non-transitory computer-readable memory devices upon which a set of instructions are stored, the one or more non-transitory computer-readable memory devices electronically coupled with the one or more processors to implement at least one instruction of the set of instructions;
a user group data storage module electronically coupled with the one or more non-transitory computer-readable memory devices and including data associated with a plurality of user groups of the social media server, each user group containing a plurality of individual users; and
a commercial content module electronically coupled with the one or more non-transitory computer-readable memory devices for transmitting data associated with commercial content to one or more electronic devices electronically coupled with the social media server based upon data associated with at least one user group of the plurality of user groups.

14. A method, comprising:
(a) retrieving, by a social media server having one or more processors configured to read one or more instructions of a set of instructions stored on one or more non-transitory computer-readable memory devices, a first set of data associated with one or more user groups of a plurality of user groups electronically coupled with the social media server;
(b) retrieving, by the social media server, a second set of data associated with another one or more user group of the plurality of user groups;
(c) matching, by a matching module of the social media server, the one or more user group with the another one or more user groups based one or more matches among the first set of data with the second set of data;
(d) providing, by a communication module of the social media server, substantially realtime communication between the one or more user group and the another one or more user group based upon a match by the matching module.

15. The method of claim 14, wherein the first set of data and the second set of data correspond to a common location of the respective user groups.

16. The method of claim 14, further comprising the step of transmitting, by a commercial content module of the social media server, data associated with advertisements for goods or services to one or more electronic devices electronically coupled with the social media server.

17. The method of claim 14, further comprising the step of transmitting, by a commercial content module of the social media server, data associated with offers for discounts for goods or services to one or more electronic devices electronically coupled with the social media server.

18. The method of claim 14, further comprising the step of transmitting data, by an application programming interface module of the social media server, to one or more third party services external to the social media server.

19. The method of claim 14, further comprising the step of retrieving data, by an application programming interface module of the social media server, from one or more third party services external to the social media server.

20. The method of claim 14, further comprising the step of applying an electronic payment, by a group payment module of the social media server, to a good or service.
